(19) United States
(12) Patent Application Publication
(10) Pub. No.: US 2023/0005255 A1
(43) Pub. Date: Jan. 5, 2023

(54) ANALYSIS DEVICE AND COMPUTER-READABLE RECORDING MEDIUM STORING ANALYSIS PROGRAM

(71) Applicant: FUJITSU LIMITED, Kawasaki-shi (JP)

(72) Inventors: Tomonori KUBOTA, Kawasaki (JP); Takanori Nakao, Kawasaki (JP); Yasuyuki Murata, Shizuoka (JP)

(73) Assignee: FUJITSU LIMITED, Kawasaki-shi (JP)

(21) Appl. No.: 17/939,137

(22) Filed: Sep. 7, 2022

Related U.S. Application Data
(63) Continuation of application No. PCT/JP2020/017823, filed on Apr. 24, 2020.

(51) Int. Cl. G06V 10/98; G06N 3/08; G06V 10/75

(52) U.S. Cl. CPC G06V 10/98; G06N 3/084; G06V 10/751

(57) ABSTRACT

An analysis device includes a processor configured to: execute a first learning process on a generative model for images such that the images that bring a recognition result of an image recognition process into a preassigned state are generated; execute a second learning process on the generative model on which the first learning process has been executed, while gradually changing recognition accuracy of the images generated by the generative model on which the first learning process has been executed, to desired recognition accuracy; acquire each piece of information on back-error propagation calculated by executing the image recognition process, for the images with each level of the recognition accuracy generated through a course of the second learning process; and generate evaluation information indicating each of image parts that cause erroneous recognition at each level of the recognition accuracy, based on the acquired each piece of the information on the back-error propagation.

### CROSS-REFERENCE TO RELATED APPLICATION

This application is a continuation application of International Application PCT/JP2020/017823 filed on Apr. 24, 2020 and designated the U.S., the entire contents of which are incorporated herein by reference.

### FIELD

The embodiments discussed herein are related to an analysis device and an analysis program.

### BACKGROUND

Traditionally, in image recognition processing using a convolutional neural network (CNN), an analysis technique for analyzing an image part that causes erroneous recognition when erroneous recognition has happened has been known. As an example, a score maximization method (activation maximization) and the like can be mentioned.

Japanese Laid-open Patent Publication No. 2018-097807, Japanese Laid-open Patent Publication No. 2018-045350 and Ramprasaath R. Selvaraju, et al.: Grad-cam: Visual explanations from deep networks via gradient-based localization. The IEEE International Conference on Computer Vision (ICCV), pp. 618-626, 2017 are disclosed as related art.

### SUMMARY

According to an aspect of the embodiments, an analysis device includes: a memory; and a processor coupled to the memory and configured to: execute a first learning process on a generative model for images such that the images that bring a recognition result of an image recognition process into a preassigned state are generated; execute a second learning process on the generative model on which the first learning process has been executed, while gradually changing recognition accuracy of the images generated by the generative model on which the first learning process has been executed, to desired recognition accuracy; acquire each piece of information on back-error propagation calculated by executing the image recognition process, for the images with each level of the recognition accuracy generated through a course of the second learning process; and generate evaluation information that indicates each of image parts that cause erroneous recognition at each level of the recognition accuracy, based on the acquired each piece of the information on the back-error propagation.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of the functional configuration of an analysis device;

FIG. 2 is a diagram illustrating an example of the hardware configuration of the analysis device;

FIG. 3 is a diagram illustrating an example of the functional configuration of an image refiner initialization unit;

FIG. 4 is a first diagram illustrating an example of the functional configuration of a refined image generation unit;

FIG. 5 is a first diagram illustrating an example of the functional configuration of a map generation unit;

FIG. 6 is a first flowchart illustrating a flow of an erroneous recognition cause extraction process;

FIG. 7 is a second diagram illustrating an example of the functional configuration of a refined image generation unit;

FIG. 8 is a second diagram illustrating an example of the functional configuration of a map generation unit;

FIG. 9 is a second flowchart illustrating a flow of an erroneous recognition cause extraction process;

FIG. 10 is a second diagram illustrating an example of the functional configuration of an analysis device;

FIG. 11 is a first diagram illustrating an example of the functional configuration of a specifying unit;

FIG. 12 is a diagram illustrating a specific example of processing of a superpixel dividing unit;

FIG. 13 is a diagram illustrating a specific example of processing of an important superpixel designation unit;

FIG. 14 is a diagram illustrating a specific example of processing of an area extraction unit and a compositing unit;

FIG. 15 is a third flowchart illustrating a flow of an erroneous recognition cause extraction process;

FIG. 16 is a flowchart illustrating a flow of a changeable area specifying process;

FIG. 17 is a second diagram illustrating an example of the functional configuration of a specifying unit;

FIG. 18 is a first diagram illustrating an example of the functional configuration of a detailed cause analysis unit;

FIG. 19 is a first diagram illustrating a specific example of processing of the detailed cause analysis unit;

FIG. 20 is a first flowchart illustrating a flow of a detailed cause analysis process;

FIG. 21 is a second diagram illustrating an example of the functional configuration of a detailed cause analysis unit;

FIG. 22 is a second diagram illustrating a specific example of processing of the detailed cause analysis unit;

FIG. 23 is a second flowchart illustrating a flow of a detailed cause analysis process;

FIG. 24 is a third diagram illustrating an example of the functional configuration of a detailed cause analysis unit;

FIG. 25 is a third diagram illustrating a specific example of processing of the detailed cause analysis unit; and

FIG. 26 is a third flowchart illustrating a flow of a detailed cause analysis process.

### DESCRIPTION OF EMBODIMENTS

According to the score maximization method, by changing the input image such that the score is maximized and generating a refined image, the changed portion of the generated refined image from the input image can be visualized as an image part that causes the erroneous recognition.

However, in the case of the score maximization method, the image part after the change is completed is clearly indicated, but the image parts in the middle of the course of changing are not clearly indicated. Therefore, a user can grasp the image part affecting the maximum score, but is not allowed to grasp which image part has influence at scores in the middle of the course (recognition accuracy in the middle of the course) (for example, the degree of influence of each image part in the middle of the course).

One aspect aims to visualize the degree of influence of each image part that causes erroneous recognition.

Hereinafter, each embodiment will be described with reference to the accompanying drawings. Note that, in the present specification and the drawings, constituent elements having substantially the same functional configuration are denoted by the same reference sign, and redundant description will be omitted.

### First Embodiment

<Functional Configuration of Analysis Device>

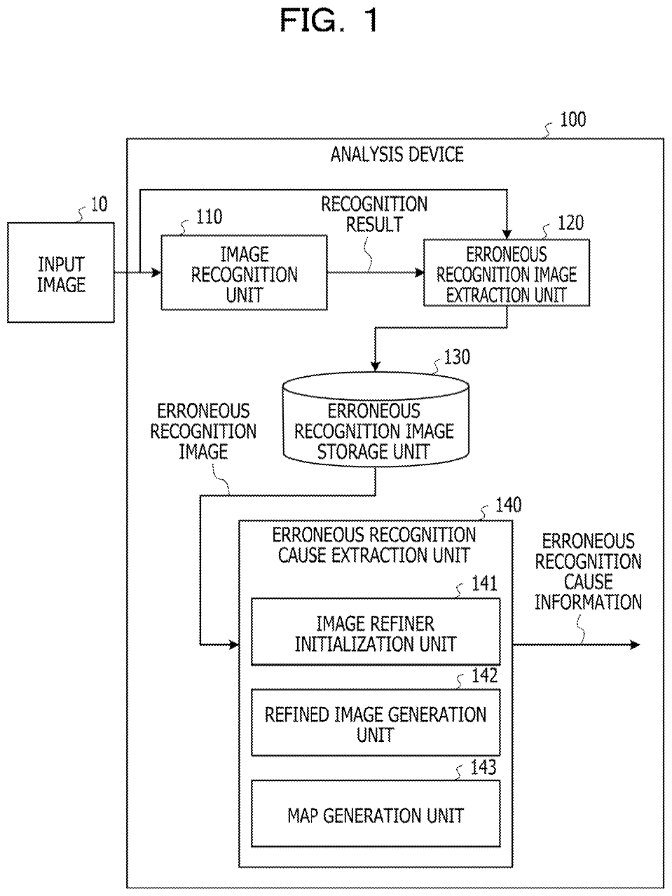

First, a functional configuration of an analysis device according to a first embodiment will be described. FIG. 1 is a first diagram illustrating an example of the functional configuration of the analysis device. An analysis program is installed in the analysis device 100, and when the program is executed, the analysis device 100 functions as an image recognition unit 110, an erroneous recognition image extraction unit 120, and an erroneous recognition cause extraction unit 140.

The image recognition unit 110 performs an image recognition process using a trained CNN. For example, the image recognition unit 110 executes the image recognition process in response to the input of an input image 10 and outputs a recognition result (for example, a label) indicating the type of an object (in the present embodiment, the type of vehicle) included in the input image 10.

The erroneous recognition image extraction unit 120 determines whether or not the recognition result included in the input image 10 (for example, a label indicating the type of the object (known)) and the recognition result by the image recognition unit 110 (for example, a label) coincide with each other. In addition, the erroneous recognition image extraction unit 120 extracts the input image when it is determined that the recognition results do not coincide with each other (when the erroneous recognition result is output), as “erroneous recognition image”, and stores the extracted erroneous recognition image in an erroneous recognition image storage unit 130.

The erroneous recognition cause extraction unit 140 specifies each image part that causes erroneous recognition at each level of recognition accuracy for the erroneous recognition image and, by outputting erroneous recognition cause information (an example of evaluation information) indicating each specified image part at each level of recognition accuracy, visualizes the degree of influence of each image part.

For example, the erroneous recognition cause extraction unit 140 includes an image refiner initialization unit 141, a refined image generation unit 142, and a map generation unit 143.

The image refiner initialization unit 141 is an example of a first learning unit. The image refiner initialization unit 141 reads the erroneous recognition image stored in the erroneous recognition image storage unit 130 and executes a first learning process for initializing an image refiner unit, by inputting the read erroneous recognition image.

The image refiner unit is a generative model that uses a CNN to change the erroneous recognition image and generate a refined image with a predetermined level of recognition accuracy. The image refiner initialization unit 141 initializes the image refiner unit by executing the first learning process and updating model parameters of the generative model.

The refined image generation unit 142 is an example of a second learning unit, and the image refiner unit initialized by the image refiner initialization unit 141 is applied. The refined image generation unit 142 reads the erroneous recognition image stored in the erroneous recognition image storage unit 130, executes a second learning process on the image refiner unit such that the recognition results have each level of recognition accuracy, and generates refined images with each level of recognition accuracy. The refined image generation unit 142 generates the refined images with each level of recognition accuracy while gradually raising the recognition accuracy to the desired recognition accuracy. Note that, among the refined images with each level of recognition accuracy, the refined image with the maximized recognition accuracy (the refined image with the desired recognition accuracy) will be referred to as “recognition accuracy-maximized refined image”.

The map generation unit 143 is an example of a generation unit. The map generation unit 143 uses a traditional analysis technique for analyzing the cause of erroneous recognition, and the like to separately generate maps indicating each image part that causes erroneous recognition at each level of recognition accuracy. The map generation unit 143 visualizes the degree of influence of each image part by outputting each generated map as the erroneous recognition cause information.

In this manner, the analysis device 100 visualizes the degree of influence of each image part that causes erroneous recognition by separately generating and outputting maps indicating each image part that causes erroneous recognition at each level of recognition accuracy.

<Hardware Configuration of Analysis Device>

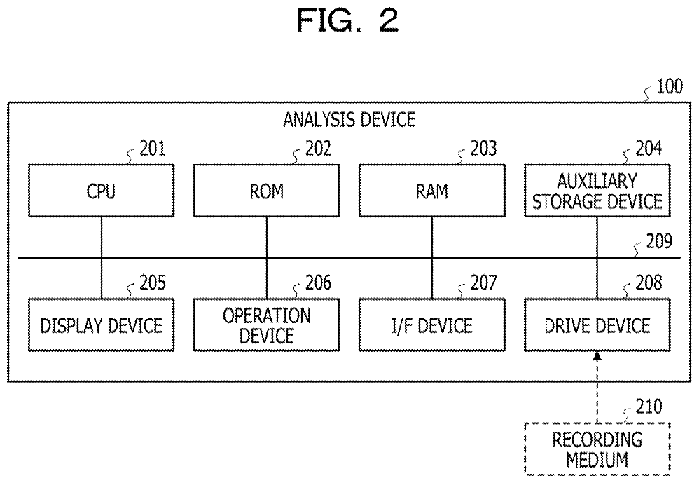

Next, a hardware configuration of the analysis device 100 will be described. FIG. 2 is a diagram illustrating an example of the hardware configuration of the analysis device. As illustrated in FIG. 2, the analysis device 100 includes a central processing unit (CPU) 201, a read only memory (ROM) 202, and a random access memory (RAM) 203. The CPU 201, the ROM 202, and the RAM 203 form a so-called computer.

In addition, the analysis device 100 includes an auxiliary storage device 204, a display device 205, an operation device 206, an interface (I/F) device 207, and a drive device 208. Note that the respective pieces of hardware of the analysis device 100 are interconnected via a bus 209.

The CPU 201 is an arithmetic device that executes various programs (such as the analysis program as an example) installed in the auxiliary storage device 204. Note that, although not illustrated in FIG. 2, an accelerator (such as a graphics processing unit (GPU) as an example) may be combined as an arithmetic device.

The ROM 202 is a nonvolatile memory. The ROM 202 functions as a main storage device that stores various programs, data, and the like demanded by the CPU 201 to execute various programs installed in the auxiliary storage device 204. For example, the ROM 202 functions as a main storage device that stores, for example, a boot program such as the Basic Input/Output System (BIOS) or the Extensible Firmware Interface (EFI).

The RAM 203 is a volatile memory such as a dynamic random access memory (DRAM) or a static random access memory (SRAM). The RAM 203 functions as a main storage device that provides a work area into which various programs installed in the auxiliary storage device 204 are loaded when executed by the CPU 201.

The auxiliary storage device 204 is an auxiliary storage device that stores various programs and information used when various programs are executed. For example, the erroneous recognition image storage unit 130 is implemented in the auxiliary storage device 204.

The display device 205 is a display device that displays various display screens containing the erroneous recognition cause information and the like. The operation device 206 is an input device for a user of the analysis device 100 to input various instructions to the analysis device 100.

The I/F device 207 is, for example, a communication device for connecting to a network (not illustrated).

The drive device 208 is a device to which a recording medium 210 is set. The recording medium 210 mentioned here includes a medium that optically, electrically, or magnetically records information, such as a compact disc read only memory (CD-ROM), a flexible disk, or a magneto-optical disk. In addition, the recording medium 210 may include a semiconductor memory or the like that electrically records information, such as a ROM or a flash memory.

Note that various programs to be installed in the auxiliary storage device 204 are installed, for example, when the distributed recording medium 210 is set to the drive device 208, and the various programs recorded in the recording medium 210 are read by the drive device 208. Alternatively, various programs to be installed in the auxiliary storage device 204 may be downloaded from a network (not illustrated) to be installed.

<Functional Configuration of Erroneous Recognition Cause Extraction Unit>

Next, among the functions implemented in the analysis device 100 according to the first embodiment, details of each unit (the image refiner initialization unit 141, the refined image generation unit 142, and the map generation unit 143) of the erroneous recognition cause extraction unit 140 will be described. Note that, hereinafter, in explaining the details of each unit, the recognition accuracy is assumed as “score”, and the refined images with each level of recognition accuracy are

assumed as
a refined image with a target score of 70%,
a refined image with a target score of 80%,
a refined image with a target score of 90%, and
a refined image with a target score of 100% (score-maximized refined image). However, the recognition accuracy is not limited to “score” (recognition accuracy other than “score” may be used as long as the recognition result is represented). In addition, the setting of the target scores with an incremental margin of 10% in the range of 70% to 100% is also merely an example, and it is assumed that an optional range and an optional incremental margin can be set.

(1) Details of Image Refiner Initialization Unit

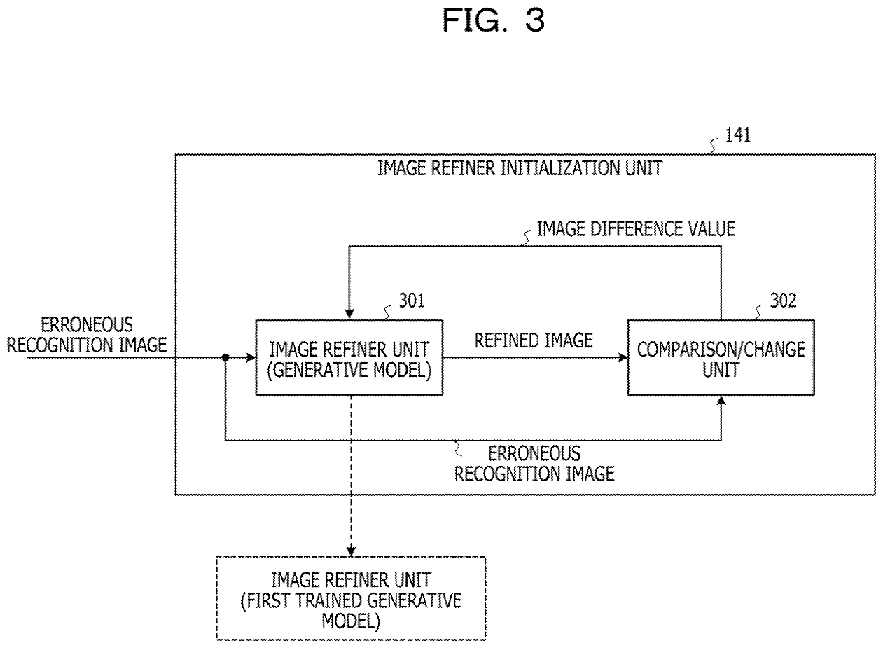

First, the details of the image refiner initialization unit 141 will be described. FIG. 3 is a diagram illustrating an example of the functional configuration of the image refiner initialization unit. As illustrated in FIG. 3, the image refiner initialization unit 141 includes an image refiner unit 301 and a comparison/change unit 302.

Among these, as described above, the image refiner unit 301 is a generative model that uses the CNN to change the erroneous recognition image and generate a refined image with a predetermined level of recognition accuracy. The image refiner initialization unit 141 executes the first learning process on the image refiner unit 301.

For example, the image refiner initialization unit 141 inputs the erroneous recognition image to the image refiner unit 301 and the comparison/change unit 302. This prompts the image refiner unit 301 to output a refined image. In addition, the refined image output from the image refiner unit 301 is input to the comparison/change unit 302.

The comparison/change unit 302 calculates the difference (image difference value) between the refined image output from the image refiner unit 301 and the erroneous recognition image input by the image refiner initialization unit 141. In addition, the comparison/change unit 302 updates the model parameters of the image refiner unit 301 by back-error propagation of the calculated image difference value.

In this manner, by executing the first learning process on the image refiner unit 301, the model parameters are updated in the image refiner unit 301 such that an erroneous recognition image in the same state as the input erroneous recognition image is output.

In the description of the present embodiment, the erroneous recognition image in the same state mentioned here will be assumed as referring to the same image as the input erroneous recognition image. However, the whole image does not necessarily have to be the same, and an image that will have the same recognition result when the image recognition process is executed may be adopted.

For example, the image refiner unit 301 is initialized by updating the model parameters such that the erroneous recognition image in the same state as each erroneous recognition image is output even when any kind of erroneous recognition image is input.

Note that the image refiner unit whose model parameters have been updated by executing the first learning process (first trained generative model) is applied to the refined image generation unit 142. This allows the second learning process to be executed using the image refiner unit in a predetermined state, without using the image refiner unit in a state in which the model parameters are initialized by random numbers and the history is unknown as in the traditional case.

(2) Details of Refined Image Generation Unit

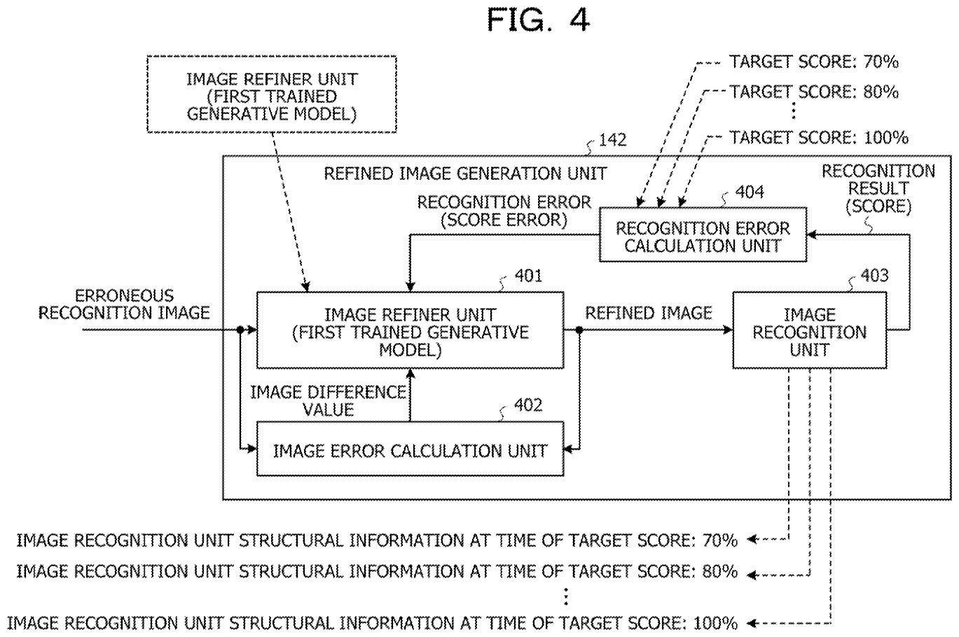

Next, the details of the refined image generation unit 142 will be described. FIG. 4 is a first diagram illustrating an example of the functional configuration of the refined image generation unit.

As illustrated in FIG. 4, the refined image generation unit 142 includes an image refiner unit 401, an image error calculation unit 402, an image recognition unit 403, and a recognition error calculation unit 404.

The image refiner unit 401 is a first trained generative model in which the model parameters have been updated by the image refiner initialization unit 141 when the first learning process was executed. The refined image generation unit 142 executes the second learning process on the image refiner unit 401 and generates refined images with each target score from the erroneous recognition image.

For example, the refined image generation unit 142 inputs the erroneous recognition image to the image refiner unit 401 and the image error calculation unit 402. This prompts the image refiner unit 401 to generate a refined image. In addition, the image refiner unit 401 changes the erroneous recognition image such that the scores of the correct answer labels match each target score when the image recognition process is executed using the generated refined images. Furthermore, the image refiner unit 401 generates a refined image such that the amount of change from the erroneous recognition image (the difference between the generated refined image and the erroneous recognition image) becomes smaller. Consequently, according to the image refiner unit 401, an image (refined image) that is visually close to the image (erroneous recognition image) before the change may be generated.

For example, the refined image generation unit 142 executes the second learning process at each target score and updates the model parameters of the image refiner unit 401 such that
the error (score error) between the score when the image recognition process is executed using the generated refined image and the target score of the correct answer label, and
the image difference value, which is the difference between the generated refined image and the erroneous recognition image,

are minimized.

The image error calculation unit 402 calculates the difference between the erroneous recognition image and the refined image generated by the image refiner unit 401 through the course of the second learning process, and inputs the image difference value to the image refiner unit 401. The image error calculation unit 402 calculates the image difference value by performing, for example, a difference (L1 difference) or structural similarity (SSIM) calculation for each pixel, and inputs the calculated image difference value to the image refiner unit 401.

The image recognition unit 403 is a trained CNN that performs the image recognition process with the refined image generated by the image refiner unit 401 as an input, and outputs the recognition result (the score of the label). Note that the recognition error calculation unit 404 is notified of the score output by the image recognition unit 403.

The recognition error calculation unit 404 calculates the error between the score notified by the image recognition unit 403 and the target score and notifies the image refiner unit 401 of the recognition error (score error).

The second learning process for the image refiner unit 401 is

performed
a preassigned number of times of learning (for example, the maximum number of times of learning=N times), or
until the score of the correct answer label exceeds a predetermined threshold value with respect to the target score, or
until the score of the correct answer label exceeds the predetermined threshold value with respect to the target score and the image difference value becomes smaller than a predetermined threshold value.

Note that the map generation unit 143 is notified of structural information of the image recognition unit 403 when the image recognition process was performed by the image recognition unit 403 on the refined images with each target score generated by the image refiner unit 401. In the present embodiment, the structural information of the image recognition unit 403

includes
image recognition unit structural information when the image recognition process was performed on the refined image with a target score of 70%,
image recognition unit structural information when the image recognition process was performed on the refined image with a target score of 80%,
image recognition unit structural information when the image recognition process was performed on the refined image with a target score of 90%, and
image recognition unit structural information when the image recognition process was performed on the refined image with a target score of 100%.

(3) Details of Map Generation Unit

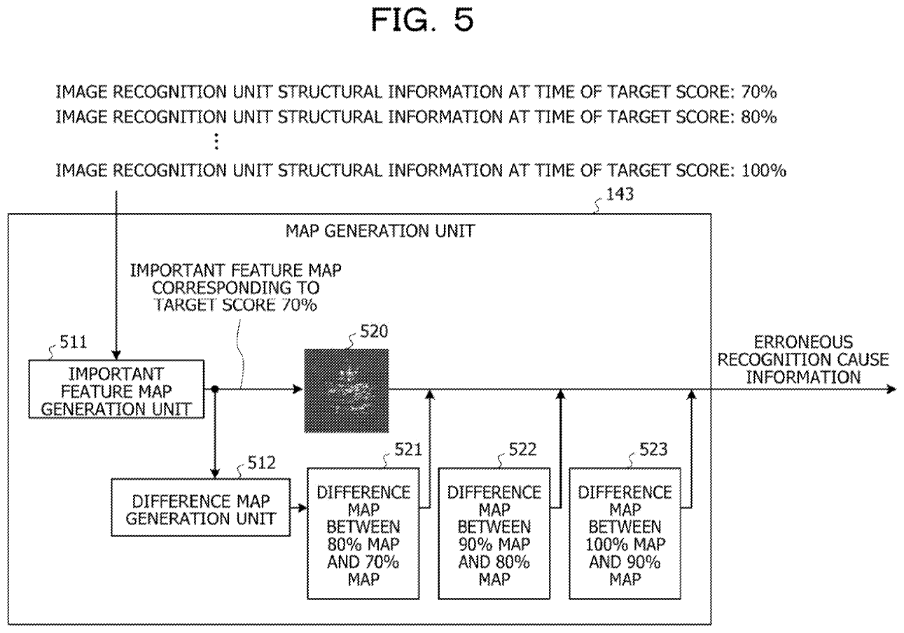

Next, the details of the map generation unit 143 will be described. FIG. 5 is a first diagram illustrating an example of the functional configuration of the map generation unit.

As illustrated in FIG. 5, the map generation unit 143 includes an important feature map generation unit 511 and a difference map generation unit 512.

The important feature map generation unit 511 acquires the structural information of the image recognition unit 403 from the refined image generation unit 142. In addition, the important feature map generation unit 511 generates “important feature map”, based on the structural information of the image recognition unit 403 by using a back propagation (BP) method, a guided back propagation (GBP) method, or a selective BP method. The important feature map is a map that visualizes the feature portion that reacted during the image recognition process.

Note that the BP method is a method in which the error of each label with respect to the target score is computed from a classification probability obtained by performing the image recognition process on the refined images with the target scores, and the feature portion is visualized by forming an image of the magnitude of a gradient obtained by back-error propagation to the input layer. In addition, the GBP method is a method in which the feature portion is visualized by forming an image of only the positive values of the gradient information as the feature portion.

Furthermore, the selective BP method is a method in which the error between the score of the correct answer label and the target score is computed and the processing is performed using the BP method or the GBP method. In the case of the selective BP method, the feature portion to be visualized is the feature portion that affects only the target score of the correct answer label.

The important feature map generation unit 511 outputs an important feature map 520 corresponding to a target score of 70% among the generated important feature maps, as one piece of the erroneous recognition cause information. In addition, the important feature map generation unit 511 notifies the difference map generation unit 512 of the generated important feature maps.

The difference map generation unit 512 generates a plurality of difference maps by calculating the differences between the important feature maps generated by the important feature map generation unit 511. For example, the difference map generation unit 512:
generates a difference map 521 by calculating the image difference value between the important feature map corresponding to a target score of 70% and the important feature map corresponding to a target score of 80%;
generates a difference map 522 by calculating the image difference value between the important feature map corresponding to a target score of 80% and the important feature map corresponding to a target score of 90%; and
generates a difference map 523 by calculating the image difference value between the important feature map corresponding to a target score of 90% and the important feature map corresponding to a target score of 100%.

In addition, the difference map generation unit 512:
outputs an important feature map obtained by adding the difference map 521 to the important feature map 520 corresponding to a target score of 70%, as one piece of the erroneous recognition cause information;
outputs an important feature map obtained by adding the difference map 521 and the difference map 522 to the important feature map 520 corresponding to a target score of 70%, as one piece of the erroneous recognition cause information; and
outputs an important feature map obtained by adding the difference map 521, the difference map 522, and the difference map 523 to the important feature map 520 corresponding to a target score of 70%, as one piece of the erroneous recognition cause information.

<Flow of Erroneous Recognition Cause Extraction Process>

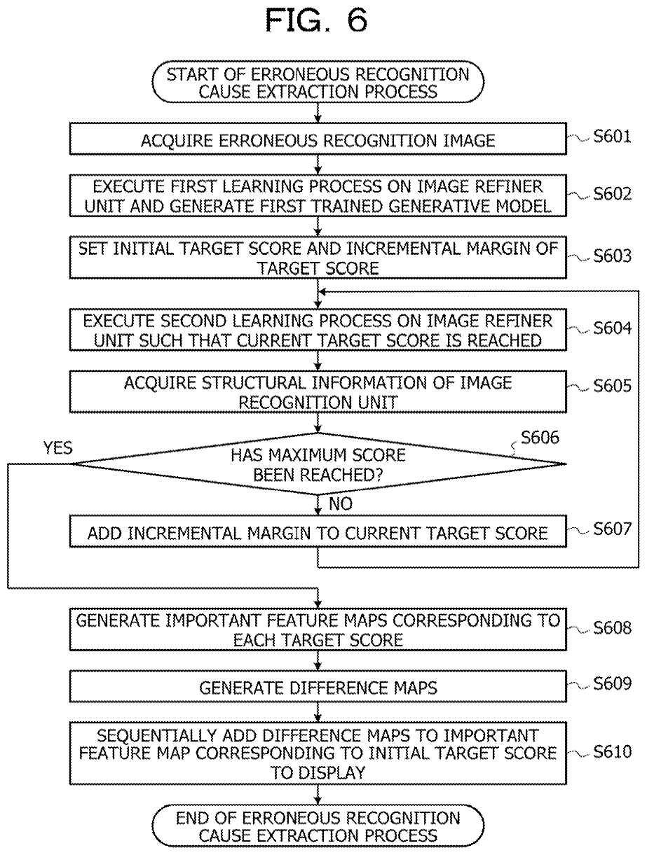

Next, the flow of an erroneous recognition cause extraction process by the erroneous recognition cause extraction unit 140 will be described. FIG. 6 is a first flowchart illustrating a flow of the erroneous recognition cause extraction process. When the erroneous recognition image is newly stored in the erroneous recognition image storage unit 130, the erroneous recognition cause extraction process illustrated in FIG. 6 is started.

In step S601, the erroneous recognition cause extraction unit 140 acquires the erroneous recognition image from the erroneous recognition image storage unit 130.

In step S602, the image refiner initialization unit 141 executes the first learning process in order to initialize the image refiner unit 301 (generative model) and generates the first trained generative model.

In step S603, the refined image generation unit 142 sets the initial target score (70%) and the incremental margin (10%) of the target score.

In step S604, the refined image generation unit 142 executes the second learning process on the image refiner unit 401 (first trained generative model) such that the current target score is reached. This prompts the image refiner unit 401 to generate a refined image with the current target score.

In step S605, the map generation unit 143 acquires the structural information of the image recognition unit 403 when the image recognition unit 403 performed the image recognition process by inputting the refined image with the current target score.

In step S606, the refined image generation unit 142 determines whether or not the current target score has reached the maximum score (100%). When it is determined in step S606 that the current target score has not reached the maximum score (in the case of NO in step S606), the process proceeds to step S607.

In step S607, the refined image generation unit 142 adds the incremental margin to the current target score and returns to step S604.

On the other hand, when it is determined in step S606 that the current target score has reached the maximum score (in the case of YES in step S606), the process proceeds to step S608.

In step S608, the map generation unit 143 generates the important feature maps corresponding to each target score, based on the structural information of the image recognition unit 403 corresponding to each target score.

In step S609, the map generation unit 143 generates the difference maps based on the important feature maps corresponding to each target score.

In step S610, the map generation unit 143 outputs the important feature map corresponding to the initial target score as one piece of the erroneous recognition cause information. In addition, the map generation unit 143 sequentially adds the difference maps to the important feature map corresponding to the initial target score and outputs each of the added important feature maps as one piece of the erroneous recognition cause information.

As is clear from the above description, the analysis device 100 according to the first embodiment executes the first learning process for initializing the image refiner unit, by inputting the erroneous recognition image, and generates the first trained generative model. In addition, the analysis device 100 according to the first embodiment generates the refined images with each level of recognition accuracy (each target score), using the first trained generative model, and generates the important feature maps based on the structural information when the image recognition process was performed on the refined images with each level of recognition accuracy. Furthermore, the analysis device 100 according to the first embodiment outputs the important feature map corresponding to the initial recognition accuracy, as one piece of the erroneous recognition cause information. Additionally, the analysis device 100 according to the first embodiment sequentially adds the difference maps between the important feature maps corresponding to each level of recognition accuracy to the important feature map corresponding to the initial recognition accuracy and outputs each of the added important feature maps, as one piece of the erroneous recognition cause information.

As described above, in the analysis device according to the first embodiment, with the recognition accuracy in the middle of the course, it may be possible to visualize which image part among the image parts that cause erroneous recognition has influence (degree of influence), by outputting the important feature maps corresponding to each level of recognition accuracy.

### Second Embodiment

In the above first embodiment, each of the important feature maps generated based on the structural information when the image recognition process was performed on the refined images with each level of recognition accuracy is output as the erroneous recognition cause information. However, the map output as the erroneous recognition cause information is not limited to the important feature map. A second embodiment will be described below focusing on differences from the first embodiment described above.

<Functional Configuration of Erroneous Recognition Cause Extraction Unit>

(1) Details of Refined Image Generation Unit

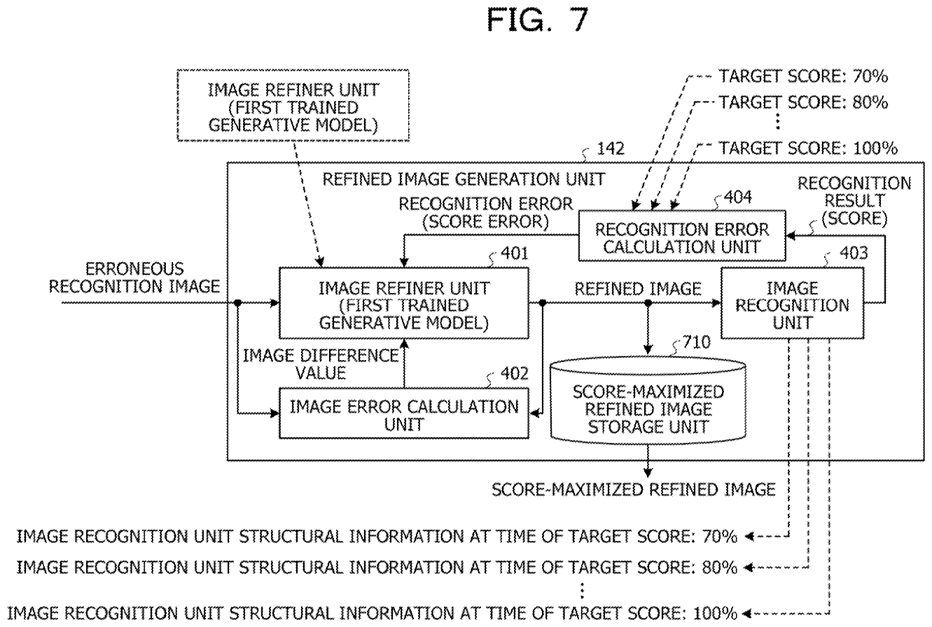

FIG. 7 is a second diagram illustrating an example of the functional configuration of a refined image generation unit. The difference from the refined image generation unit 142 described with reference to FIG. 4 in the above first embodiment is that, in the case of FIG. 7, a score-maximized refined image storage unit 710 is included.

The score-maximized refined image storage unit 710 stores the refined image with a target score of 100% (score-maximized refined image) among the refined images generated by an image refiner unit 401.

(2) Details of Map Generation Unit

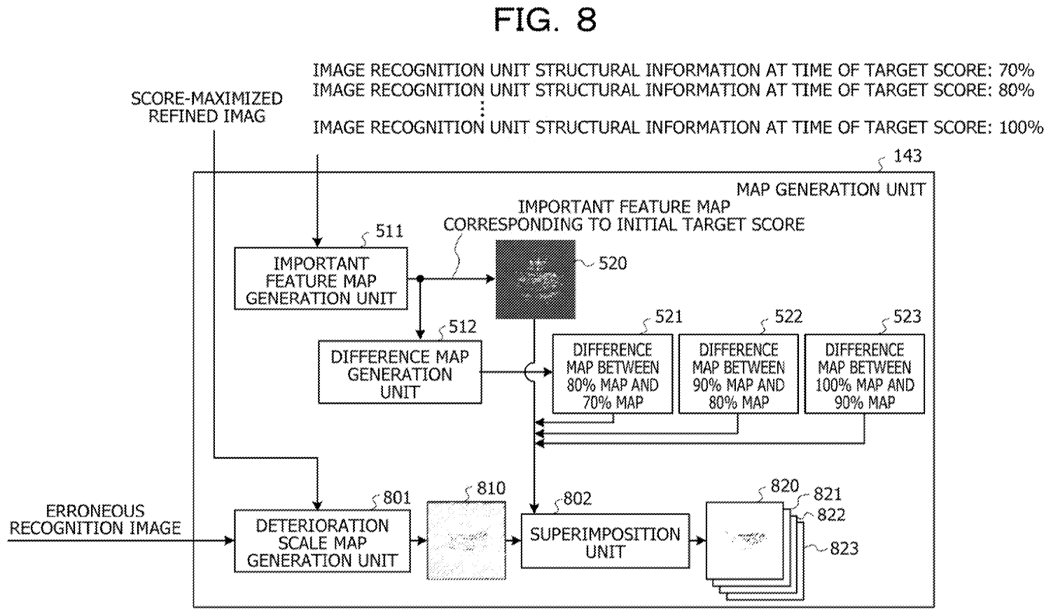

Next, the details of a map generation unit 143 will be described. FIG. 8 is a second diagram illustrating an example of the functional configuration of the map generation unit.

As illustrated in FIG. 8, the map generation unit 143 includes a deterioration scale map generation unit 801 and a superimposition unit 802 in addition to an important feature map generation unit 511 and a difference map generation unit 512.

The deterioration scale map generation unit 801 acquires the score-maximized refined image stored in the score-maximized refined image storage unit 710. In addition, the deterioration scale map generation unit 801 acquires the erroneous recognition image. Furthermore, the deterioration scale map generation unit 801 calculates the difference between the score-maximized refined image and the erroneous recognition image and generates a deterioration scale map 810.

For example, the deterioration scale map is a map indicating changed portions and the extent of change of each changed portion when the score-maximized refined image is generated from the erroneous recognition image.

The superimposition unit 802 generates an important feature index map 820 corresponding to a target score of 70%, by superimposing an important feature map 520 generated by the important feature map generation unit 511 and the deterioration scale map 810 generated by the deterioration scale map generation unit 801. In addition, the superimposition unit 802 outputs the generated important feature index map 820 corresponding to a target score of 70%, as one piece of the erroneous recognition cause information.

Furthermore, the superimposition unit 802 sequentially adds difference maps 521, 522, and 523 to the important feature index map 820 corresponding to a target score of 70% and outputs each of a plurality of important feature index maps including
an important feature index map 821 corresponding to a target score of 80%,
an important feature index map 822 corresponding to a target score of 90%, and
an important feature index map 823 corresponding to a target score of 100%,

as one piece of the erroneous recognition cause information.

<Flow of Erroneous Recognition Cause Extraction Process>

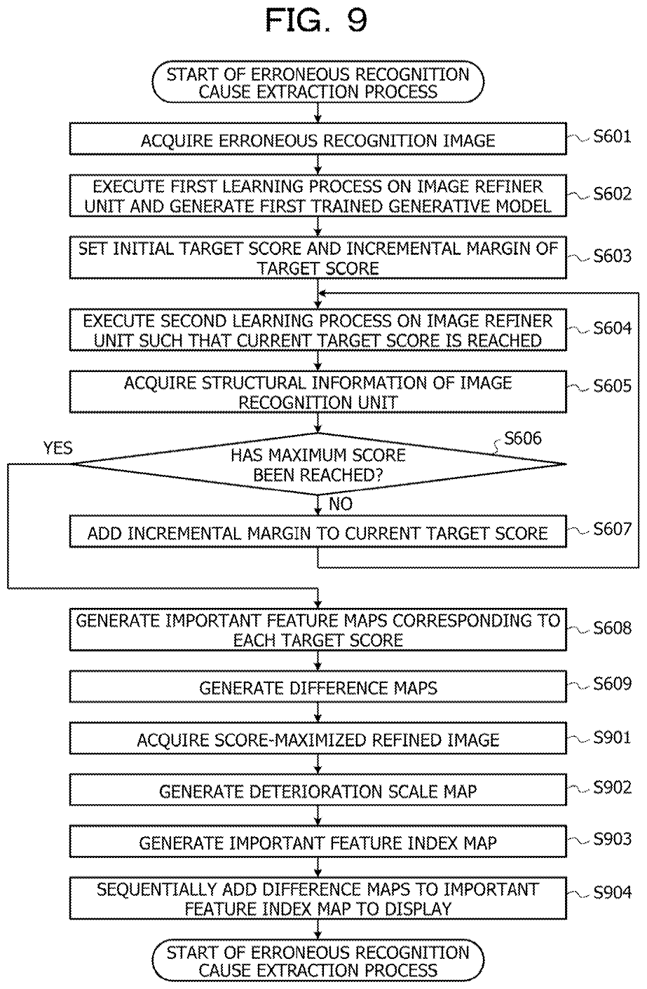

Next, the flow of an erroneous recognition cause extraction process by an erroneous recognition cause extraction unit 140 will be described. FIG. 9 is a second flowchart illustrating a flow of the erroneous recognition cause extraction process. The differences from the erroneous recognition cause extraction process described with reference to FIG. 6 in the above first embodiment are steps S901 to S904.

In step S901, the map generation unit 143 acquires the score-maximized refined image generated by the image refiner unit 401.

In step S902, the map generation unit 143 calculates the difference between the score-maximized refined image and the erroneous recognition image and generates the deterioration scale map.

In step S903, the map generation unit 143 generates the important feature index map corresponding to the initial target score, by superimposing the important feature map corresponding to the initial target score onto the deterioration scale map, and outputs the generated important feature index map, as one piece of the erroneous recognition cause information.

In step S904, the map generation unit 143 sequentially adds the difference maps to the important feature index map corresponding to the initial target score and generates the important feature index maps corresponding to each target score. In addition, the map generation unit 143 outputs each of the important feature index maps corresponding to each target score, as one piece of the erroneous recognition cause information.

As is clear from the above description, an analysis device 100 according to the second embodiment further includes the deterioration scale map generation unit, in addition to the functions provided in the analysis device 100 according to the above first embodiment, and generates the deterioration scale map. In addition, the analysis device 100 according to the second embodiment further includes the superimposition unit, generates the important feature index map by superimposing the important feature map corresponding to the initial recognition accuracy onto the deterioration scale map, and outputs the generated important feature index map as one piece of the erroneous recognition cause information. Furthermore, the analysis device 100 according to the second embodiment sequentially adds the difference maps between the important feature maps corresponding to each level of recognition accuracy to the important feature index map corresponding to the initial recognition accuracy and outputs each of the added important feature index maps, as one piece of the erroneous recognition cause information.

As described above, in the analysis device according to the second embodiment, with the recognition accuracy in the middle of the course, it may be possible to visualize which image part among the image parts that cause erroneous recognition has influence (degree of influence), by outputting the important feature index maps corresponding to each level of recognition accuracy.

### Third Embodiment

In the above first and second embodiments, the important feature maps corresponding to each level of recognition accuracy or the important feature index maps corresponding to each level of recognition accuracy are output as the erroneous recognition cause information. In contrast to this, in a third embodiment, the combinations of superpixels (changeable areas) at each level of recognition accuracy specified based on the important feature index maps corresponding to each level of recognition accuracy are output as the erroneous recognition cause information. The third embodiment will be described below focusing on differences from the first and second embodiments described above.

<Functional Configuration of Analysis Device>

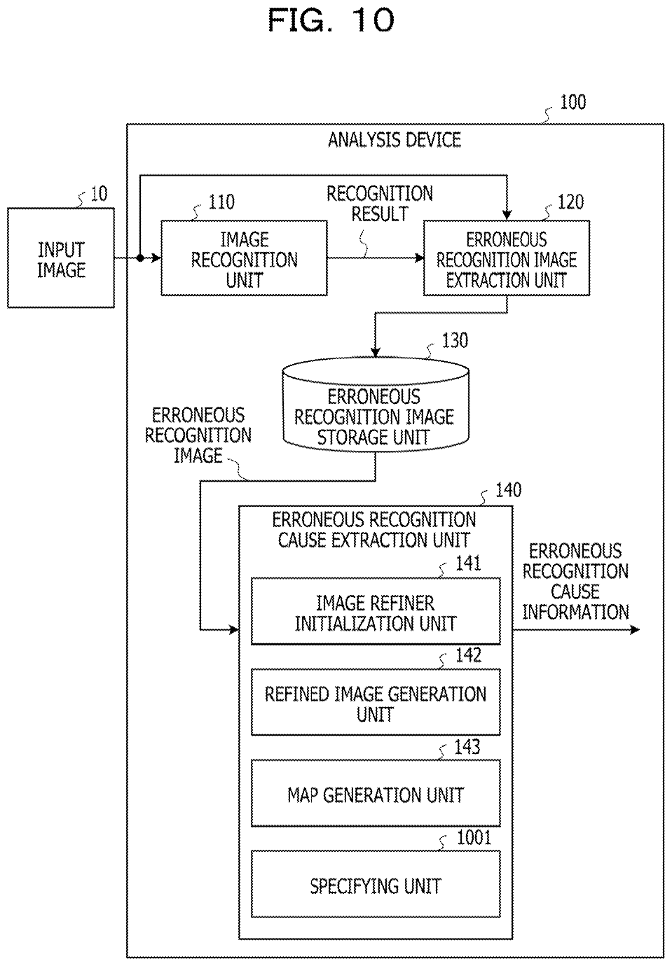

FIG. 10 is a second diagram illustrating an example of the functional configuration of an analysis device. The difference from the functional configuration of the analysis device 100 described with reference to FIG. 1 in the above first embodiment is that, in the case of FIG. 10, an erroneous recognition cause extraction unit 140 includes a specifying unit 1001.

The specifying unit 1001 replaces a changeable area in the erroneous recognition image defined based on the generated important feature index map with the generated refined image. In addition, the specifying unit 1001 executes an image recognition process by inputting the erroneous recognition image in which the changeable area is replaced with the refined image, and determines the effect of the replacement from the output recognition result (the score of the label).

Furthermore, the specifying unit 1001 repeats the image recognition process while modifying the dimensions of the changeable area and specifies, from the recognition result (the score of the label), a combination of superpixels (changeable area) that causes erroneous recognition at each level of recognition accuracy (each target score). Additionally, the specifying unit 1001 outputs the combinations of superpixels (changeable areas) that cause erroneous recognition, which have been specified at each level of recognition accuracy, as the erroneous recognition cause information.

In this manner, by referring to the effect of the replacement when the changeable area is replaced with the refined image, each image part that causes erroneous recognition at each level of recognition accuracy (each target score) may be accurately specified.

<Functional Configuration of Specifying Unit>

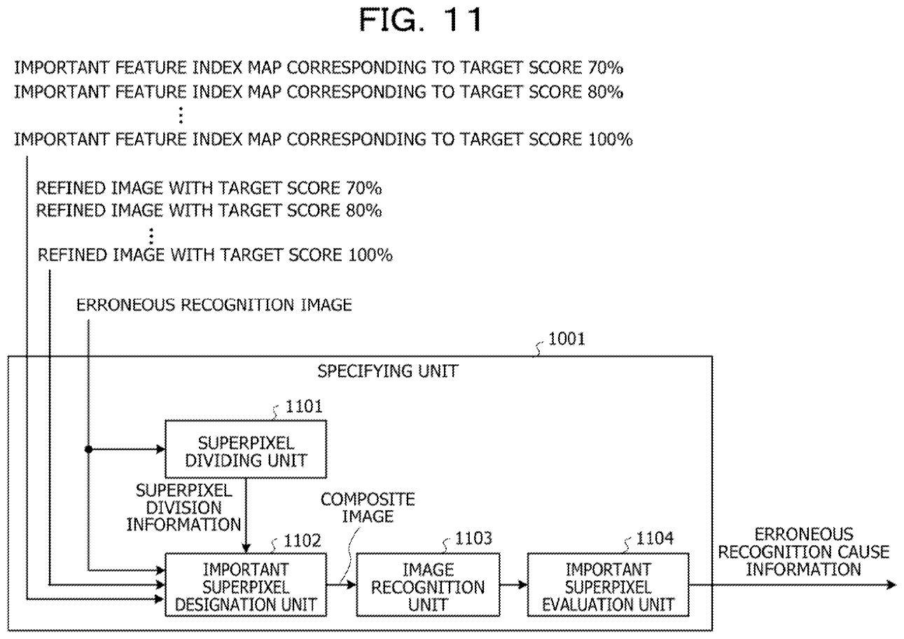

Next, a functional configuration of the specifying unit 1001 will be described. FIG. 11 is a first diagram illustrating an example of the functional configuration of the specifying unit. As illustrated in FIG. 11, the specifying unit 1001 includes a superpixel dividing unit 1101, an important superpixel designation unit 1102, an image recognition unit 1103, and an important superpixel evaluation unit 1104.

The superpixel dividing unit 1101 divides the erroneous recognition image into “superpixels”, which are areas for each component of the object (a vehicle in the present embodiment) included in the erroneous recognition image, and outputs superpixel division information. Note that, in dividing the erroneous recognition image into superpixels, an existing dividing function is used, or a CNN or the like trained so as to divide for each component of the vehicle is used.

The important superpixel designation unit 1102 separately adds, for each superpixel,
the value of each pixel of the important feature index map corresponding to a target score of 70%,
the value of each pixel of the important feature index map corresponding to a target score of 80%,
the value of each pixel of the important feature index map corresponding to a target score of 90%, and
the value of each pixel of the important feature index map corresponding to a target score of 100%,

which have been generated by a superimposition unit 802 based on the superpixel division information output by the superpixel dividing unit 1101.

In addition, among respective superpixels, the important superpixel designation unit 1102 extracts a superpixel whose additional value of respective added pixels is equal to or higher than a predetermined threshold value (important feature index threshold value) for each target score. Furthermore, the important superpixel designation unit 1102 defines superpixels selected from among the superpixels extracted for each target score and combined, as a changeable area, and defines the superpixels other than the combined superpixels as an unchangeable area.

Additionally, the important superpixel designation unit 1102 extracts the image portion corresponding to the unchangeable area from the erroneous recognition image, extracts the image portion corresponding to the changeable area from the refined image, and generates a composite image by compositing the two extracted image portions. Since
the refined image with a target score of 70%,
the refined image with a target score of 80%,
the refined image with a target score of 90%, and
the refined image with a target score of 100%,

are output from an image refiner unit 401, the important superpixel designation unit 1102 generates
the composite image corresponding to a target score of 70%,
the composite image corresponding to a target score of 80%,
the composite image corresponding to a target score of 90%, and
the composite image corresponding to a target score of 100%,

for each of the refined images.

Note that the important superpixel designation unit 1102 increases the number of superpixels to be extracted (expands the changeable area and narrows down the unchangeable area), by slowly lowering the important feature index threshold value used when defining the changeable area and the unchangeable area. In addition, the important superpixel designation unit 1102 updates the changeable area and the unchangeable area while modifying the combination of superpixels selected from among the extracted superpixels.

The image recognition unit 1103, which has the same function as the function of the image recognition unit 403 in FIG. 4, performs the image recognition process by inputting each composite image generated by the important superpixel designation unit 1102 and outputs the recognition result (the score of the label).

The important superpixel evaluation unit 1104 acquires the recognition result (the score of the label) output from the image recognition unit 1103. As described above, for each of the target scores, the important superpixel designation unit 1102 generates a number of composite images according to the number of times the important feature index threshold value is lowered and the number of combinations of superpixels. Therefore, the important superpixel evaluation unit 1104 acquires a number of scores according to the number, for each of the target scores. In addition, the important superpixel evaluation unit 1104 specifies the combination of superpixels (changeable area) that causes erroneous recognition at each of the target scores, based on the recognition result, and outputs the specified combination as the erroneous recognition cause information.

<Specific Example of Processing of Each Unit of Specifying Unit>

Next, a specific example of processing of each unit (here, the superpixel dividing unit 1101 and the important superpixel designation unit 1102) of the specifying unit 1001 will be described.

(1) Specific Example of Processing of Superpixel Dividing Unit

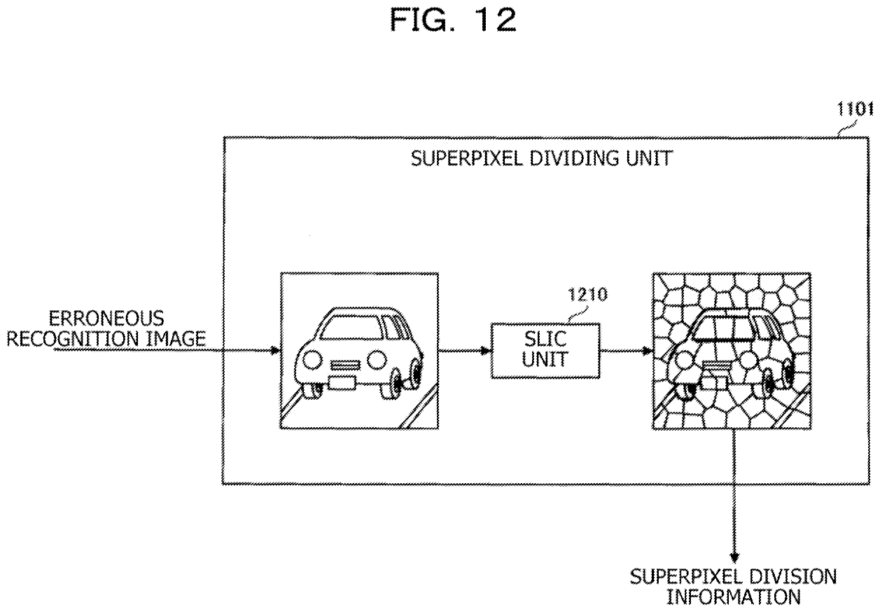

First, a specific example of processing of the superpixel dividing unit 1101 will be described. FIG. 12 is a diagram illustrating a specific example of processing of the superpixel dividing unit. As illustrated in FIG. 12, the superpixel dividing unit 1101 includes, for example, a simple linear iterative clustering (SLIC) unit 1210 that performs SLIC processing. The SLIC unit 1210 divides the erroneous recognition image into superpixels, which are partial images for each component of the vehicle included in the erroneous recognition image. In addition, the superpixel dividing unit 1101 outputs the superpixel division information about the erroneous recognition image generated by the SLIC unit 1210 dividing the erroneous recognition image into superpixels.

(2) Specific Example of Processing of Important Superpixel Designation Unit

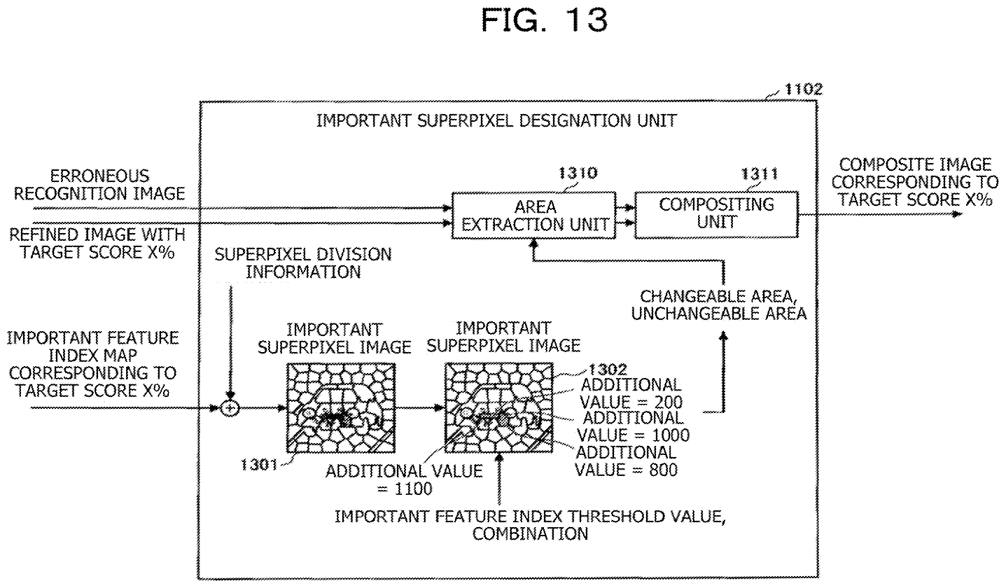

Next, a specific example of processing of the important superpixel designation unit 1102 will be described. FIG. 13 is a diagram illustrating a specific example of processing of the important superpixel designation unit.

As illustrated in FIG. 13, the important superpixel designation unit 1102 includes an area extraction unit 1310 and a compositing unit 1311.

The important superpixel designation unit 1102

overlays
the important feature index maps corresponding to a target score of 70% to a target score of 100% output from the superimposition unit 802 (here, the important feature index map corresponding to a target score X % is assumed for simplification of explanation), and
the superpixel division information output from the superpixel dividing unit 1101. This prompts the important superpixel designation unit 1102 to generate an important superpixel image 1301 corresponding to the target score X %.

In addition, the important superpixel designation unit 1102 adds the value of each pixel of the important feature index map corresponding to the target score X % for each of the superpixels in the generated important superpixel image 1301.

Furthermore, the important superpixel designation unit 1102 determines whether or not the additional value for each superpixel is equal to or higher than the important feature index threshold value and extracts the superpixel determined to have an additional value equal to or higher than the important feature index threshold value. Note that, in FIG. 13, an important superpixel image 1302 corresponding to the target score X % clearly indicates an example of the additional values for each superpixel.

In addition, the important superpixel designation unit 1102 defines superpixels selected from among the extracted superpixels and combined, as a changeable area, and defines the superpixels other than the combined superpixels as an unchangeable area. Furthermore, the important superpixel designation unit 1102 notifies the area extraction unit 1310 of the defined changeable area and unchangeable area.

The area extraction unit 1310 extracts the image portion corresponding to the unchangeable area from the erroneous recognition image.

In addition, the area extraction unit 1310 extracts the image portions corresponding to the changeable area from the refined images with a target score of 70% to a target score of 100% (here, the refined image with the target score X % is assumed for simplification of explanation).

The compositing unit 1311 composites the image portion corresponding to the changeable area extracted from the refined image with the target score X % and the image portion corresponding to the unchangeable area extracted from the erroneous recognition image, and generates a composite image corresponding to the target score X %.

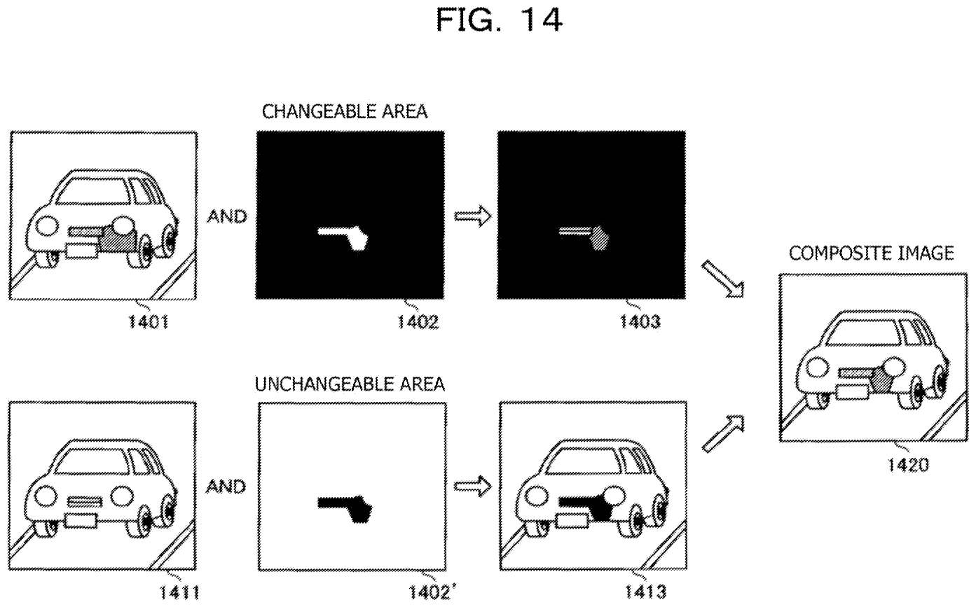

FIG. 14 is a diagram illustrating a specific example of processing of the area extraction unit and the compositing unit. In FIG. 14, the upper part illustrates a situation in which the area extraction unit 1310 extracts the image portion (the white portion of an image 1402) corresponding to the changeable area from a refined image 1401 with the target score X %.

Meanwhile, in FIG. 14, the lower part illustrates a situation in which the area extraction unit 1310 extracts the image portion (the white portion of an image 1402′) corresponding to the unchangeable area from an erroneous recognition image 1411. Note that the image 1402′ is an image obtained by inverting the white portion and the black portion of the image 1402 (for convenience of explanation, the white portion in the lower part of FIG. 14 is assumed as the image portion corresponding to the unchangeable area).

As illustrated in FIG. 14, the compositing unit 1311 composites
an image portion 1403 corresponding to the changeable area of the refined image 1401 with the target score X %, and
an image portion 1413 corresponding to the unchangeable area of the erroneous recognition image 1411,

which have been output from the area extraction unit 1310, and generates a composite image 1420 corresponding to the target score X %.

In this manner, when generating the composite image 1420, the specifying unit 1001 adds the value of each pixel of the important feature index map corresponding to the target score X % in superpixel units. Consequently, according to the specifying unit 1001, the area to be replaced with the refined image with the target score X % may be specified in superpixel units.

<Flow of Erroneous Recognition Cause Extraction Process>

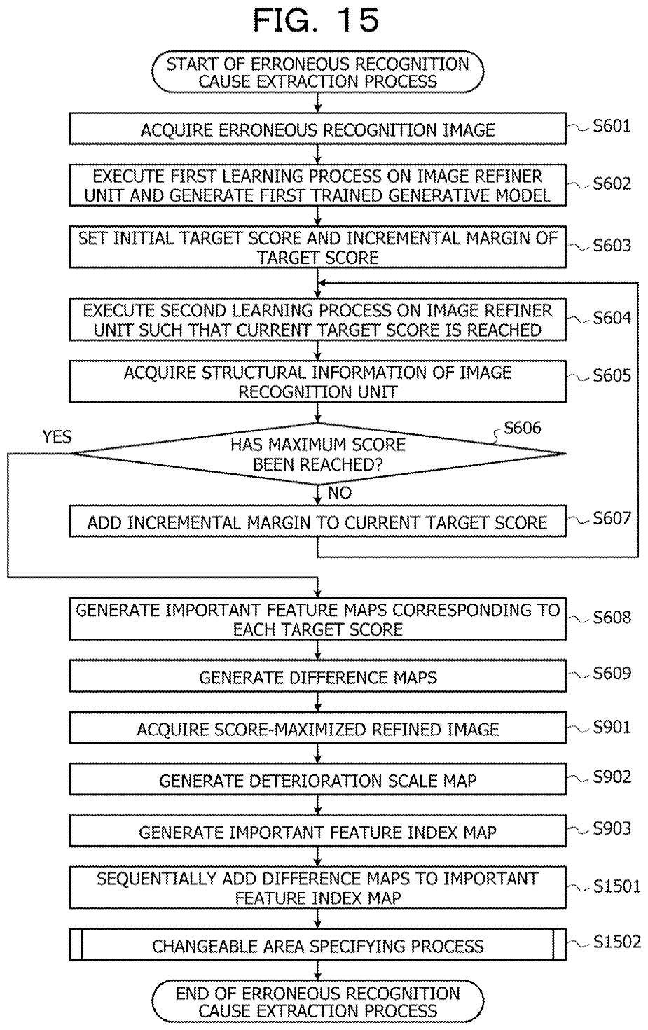

Next, the flow of an erroneous recognition cause extraction process by the erroneous recognition cause extraction unit 140 will be described. FIG. 15 is a third flowchart illustrating a flow of the erroneous recognition cause extraction process. The differences from the erroneous recognition cause extraction process described with reference to FIG. 9 in the above second embodiment are steps S1501 and S1502.

In step S1501, a map generation unit 143 sequentially adds the difference maps to the important feature index map corresponding to the initial target score and generates the important feature index maps corresponding to each target score.

In step S1502, the specifying unit 1001 executes a changeable area specifying process that outputs the changeable areas at each level of recognition accuracy specified based on
the erroneous recognition image,
the refined images with each target score, and
the important feature index maps corresponding to each target score,

as the erroneous recognition cause information. Note that the details of the changeable area specifying process will be described later.

<Flow of Changeable Area Specifying Process>

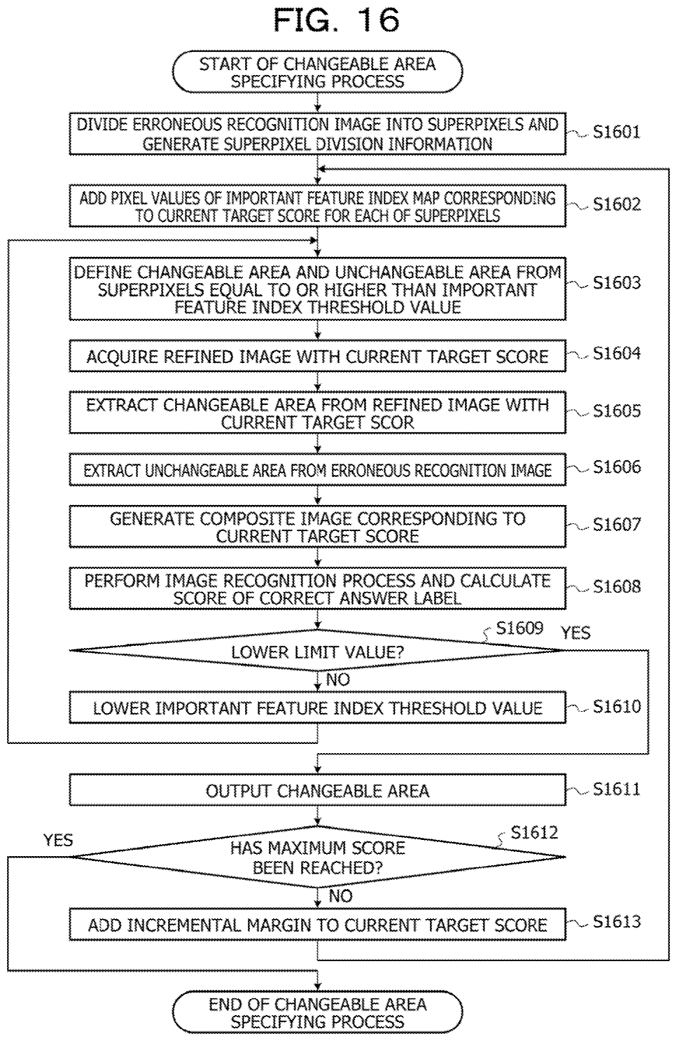

Next, the flow of the changeable area specifying process (step S1502 in FIG. 15) will be described. FIG. 16 is a flowchart illustrating a flow of the changeable area specifying process.

In step S1601, the superpixel dividing unit 1101 divides the erroneous recognition image into superpixels and generates the superpixel division information.

In step S1602, the important superpixel designation unit 1102 adds the value of each pixel of the important feature index map corresponding to the current target score in superpixel units. Note that, at the start of the changeable area specifying process, it is assumed that the initial target score (70%) is set as the default value for “current target score”.

In step S1603, the important superpixel designation unit 1102 extracts a superpixel whose additional value is equal to or higher than the important feature index threshold value and defines the changeable area by combining superpixels selected from among the extracted superpixels. In addition, the important superpixel designation unit 1102 defines the superpixels other than the combined superpixels as the unchangeable area.

In step S1604, the important superpixel designation unit 1102 reads the refined image with the current target score.

In step S1605, the important superpixel designation unit 1102 extracts the image portion corresponding to the changeable area from the refined image with the current target score.

In step S1606, the important superpixel designation unit 1102 extracts the image portion corresponding to the unchangeable area from the erroneous recognition image.

In step S1607, the important superpixel designation unit 1102 composites the image portion corresponding to the changeable area extracted from the refined image and the image portion corresponding to the unchangeable area extracted from the erroneous recognition image, and generates a composite image corresponding to the current target score.

In step S1608, the image recognition unit 1103 performs the image recognition process by inputting the composite image corresponding to the current target score and calculates the score of the correct answer label. In addition, the important superpixel evaluation unit 1104 acquires the score of the correct answer label calculated by the image recognition unit 1103.

In step S1609, the important superpixel designation unit 1102 determines whether or not the important feature index threshold value has reached a lower limit value. When it is determined in step S1609 that the lower limit value has not been reached (in the case of NO in step S1609), the process proceeds to step S1610.

In step S1610, the important superpixel designation unit 1102 lowers the important feature index threshold value and then returns to step S1603.

On the other hand, when it is determined in step S1609 that the lower limit value has been reached (in the case of YES in step S1609), the process proceeds to step S1611.

In step S1611, the important superpixel evaluation unit 1104 specifies the combination of superpixels (changeable area) that causes erroneous recognition at the current target score, based on the acquired score of the correct answer label, and outputs the specified combination of superpixels (changeable area) as one piece of the erroneous recognition cause information.

In step S1612, the specifying unit 1001 determines whether or not the current target score has reached the maximum score (100%). When it is determined in step S1612 that the current target score has not reached the maximum score (in the case of NO in step S1612), the process proceeds to step S1613.

In step S1613, the specifying unit 1001 adds the incremental margin to the current target score and returns to step S1602.

On the other hand, when it is determined in step S1612 that the current target score has reached the maximum score (in the case of YES in step S1612), the changeable area specifying process is ended.

As is clear from the above description, the analysis device 100 according to the third embodiment further includes the specifying unit 1001, in addition to the functions provided in the analysis device 100 according to the above second embodiment. In addition, the analysis device 100 according to the third embodiment outputs the combinations of superpixels (changeable areas) at each level of recognition accuracy specified by the specifying unit 1001 based on the important feature index maps corresponding to each level of recognition accuracy, as the erroneous recognition cause information.

As described above, in the analysis device according to the third embodiment, with the recognition accuracy in the middle of the course, it may be possible to visualize which image part among the image parts that cause erroneous recognition has influence (degree of influence), by outputting the changeable areas corresponding to each level of recognition accuracy.

### Fourth Embodiment

In the above third embodiment, the combinations of superpixels (changeable areas) corresponding to each level of recognition accuracy have been described as being output as the erroneous recognition cause information. However, the method of outputting the erroneous recognition cause information is not limited to this, and for example, an important portion in the changeable area may be output in pixel units. A fourth embodiment will be described below focusing on differences from the third embodiment described above.

<Functional Configuration of Specifying Unit>

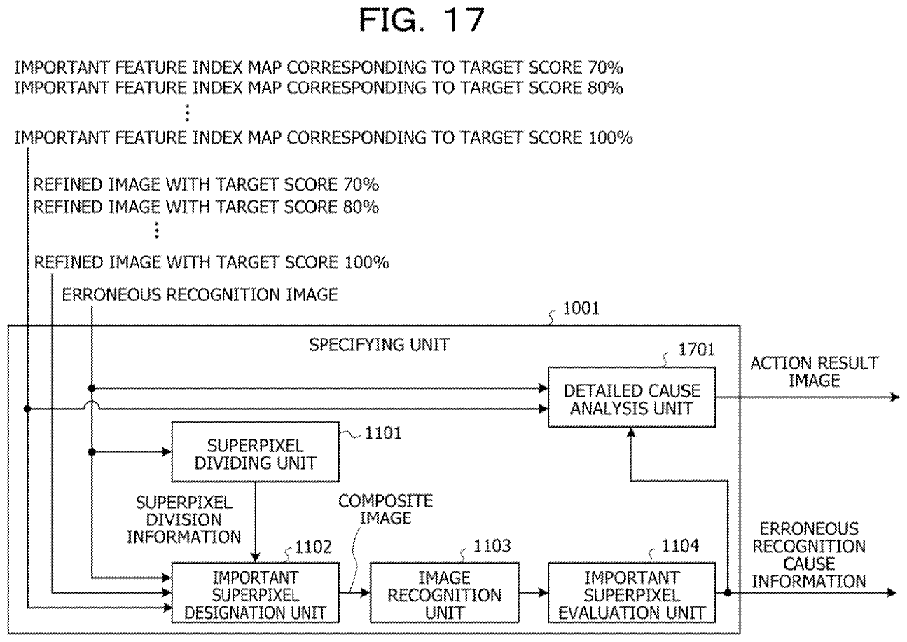

First, a functional configuration of a specifying unit in an analysis device 100 according to the fourth embodiment will be described. FIG. 17 is a second diagram illustrating an example of the functional configuration of the specifying unit 1001. The difference from the functional configuration of the specifying unit 1001 illustrated in FIG. 11 is that a detailed cause analysis unit 1701 is included.

The detailed cause analysis unit 1701 calculates an important portion in the changeable area, using the erroneous recognition image and the refined images with each target score, and outputs the calculated important portion as an action result image.

<Functional Configuration of Detailed Cause Analysis Unit>

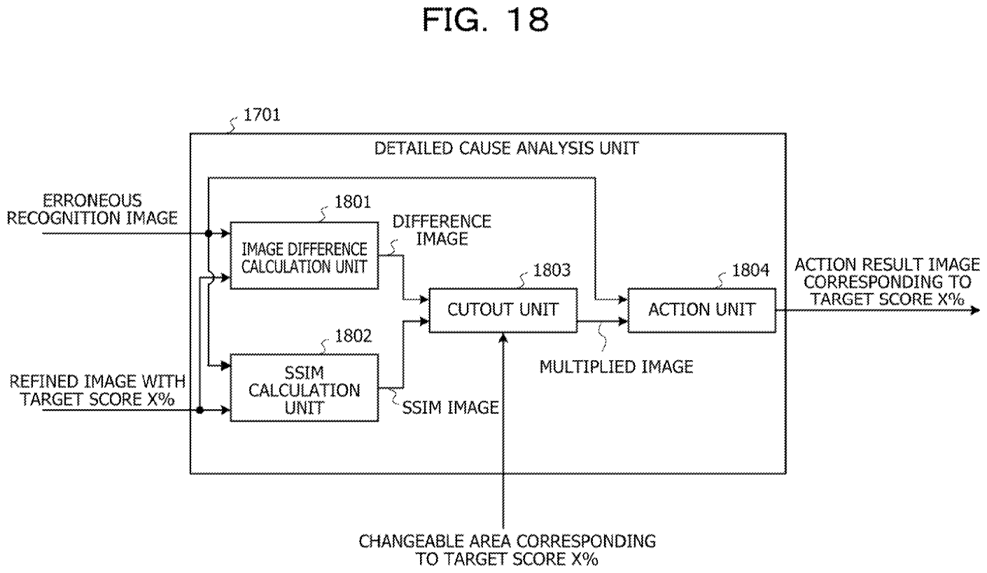

Next, a functional configuration of the detailed cause analysis unit 1701 will be described. FIG. 18 is a first diagram illustrating an example of the functional configuration of the detailed cause analysis unit. As illustrated in FIG. 18, the detailed cause analysis unit 1701 includes an image difference calculation unit 1801, an SSIM calculation unit 1802, a cutout unit 1803, and an action unit 1804.

The image difference calculation unit 1801 calculates the differences in pixel units between the erroneous recognition image and the refined images with each target score (here, the refined image with the target score X % is assumed for simplification of explanation), and output a difference image.

The SSIM calculation unit 1802 outputs an SSIM image by performing an SSIM calculation using the erroneous recognition image and the refined image with the target score X %.

The cutout unit 1803 cuts out the image portion for the changeable area corresponding to the target score X % from the difference image. In addition, the cutout unit 1803 cuts out the image portion for the changeable area corresponding to the target score X % from the SSIM image. Furthermore, the cutout unit 1803 generates a multiplied image by multiplying the difference image and the SSIM image obtained by cutting out the image portions for the changeable area at the target score X %.

The action unit 1804 generates the action result image corresponding to the target score X %, based on the erroneous recognition image and the multiplied image.

<Specific Example of Processing of Detailed Cause Analysis Unit>

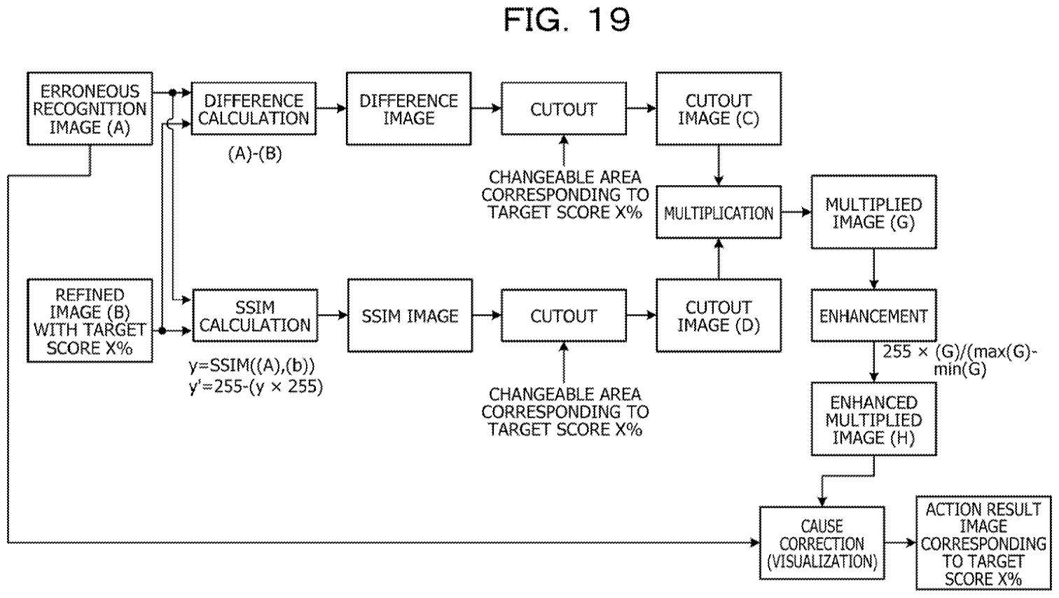

Next, a specific example of processing of the detailed cause analysis unit 1701 will be described. FIG. 19 is a diagram illustrating a specific example of processing of the detailed cause analysis unit.

As illustrated in FIG. 19, first, in the image difference calculation unit 1801, the difference between the erroneous recognition image (A) and the refined image (B) with the target score X % (=(A)−(B)) is calculated, and the difference image is output. The difference image contains pixel correction information at each image part that causes erroneous recognition at the target score X %.

Subsequently, in the SSIM calculation unit 1802, the SSIM calculation is performed based on the erroneous recognition image (A) and the refined image (B) with the target score X % (y=SSIM((A), (B)). Furthermore, in the SSIM calculation unit 1802, the result of the SSIM calculation is inverted (y′=255−(y×255)), whereby the SSIM image is output. The SSIM image is an image in which each image part that causes erroneous recognition at the target score X % is located with high accuracy and represents that the difference is larger when the pixel value is higher, and that the difference is smaller when the pixel value is lower. Note that the process of inverting the result of the SSIM calculation may be performed, for example, by calculating y′=1− y.

Subsequently, in the cutout unit 1803, the image portion is cut out from the difference image for the changeable area corresponding to the target score X %, and a cutout image (C) is output. Similarly, in the cutout unit 1803, the image portion is cut out from the SSIM image for the changeable area corresponding to the target score X %, and a cutout image (D) is output.

Here, the changeable area corresponding to the target score X % is obtained by specifying an area of the image portion that causes erroneous recognition at the target score X %, and the detailed cause analysis unit 1701 aims to further analyze the cause at the granularity of pixels in the specified area.

Therefore, the cutout unit 1803 multiplies the cutout image (C) and the cutout image (D) and generates a multiplied image (G). The multiplied image (G) is nothing but pixel correction information in which the pixel correction information at each image part that causes erroneous recognition at the target score X % is located with higher accuracy.

In addition, the cutout unit 1803 performs an enhancement process on the multiplied image (G) and outputs an enhanced multiplied image (H). Note that the cutout unit 1803 calculates the enhanced multiplied image (H) based on the following formula.

Enhanced Multiplied Image (H)=255×(G)/(max(G)−min(G)) (Formula 3)

Subsequently, the action unit 1804 visualizes the important portion by subtracting the enhanced multiplied image (H) from the erroneous recognition image (A) and generates an action result image corresponding to the target score X %.

Note that the method for the enhancement process illustrated in FIG. 19 is merely an example, and the enhancement process may be performed by another method as long as the method makes it easier to identify the important portion when visualized.

<Flow of Detailed Cause Analysis Process>

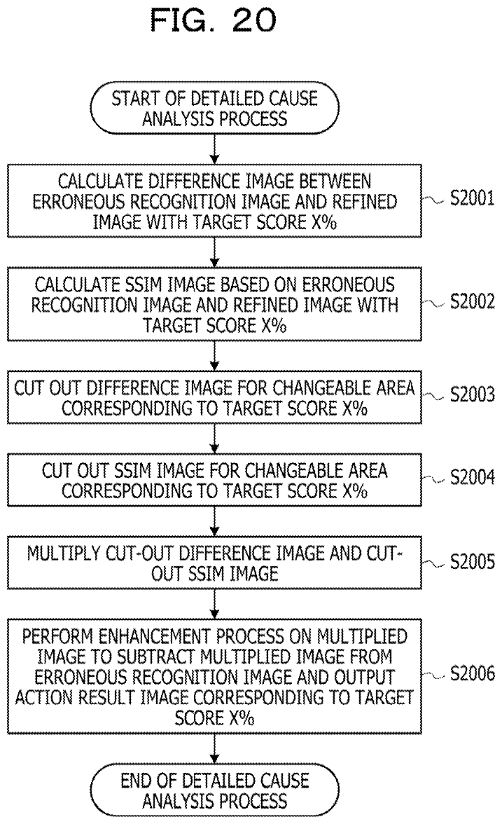

Next, the flow of a detailed cause analysis process by the detailed cause analysis unit 1701 will be described. FIG. 20 is a first flowchart illustrating a flow of the detailed cause analysis process.

In step S2001, the image difference calculation unit 1801 calculates the difference image between the erroneous recognition image and the refined image with the target score X %.

In step S2002, the SSIM calculation unit 1802 calculates the SSIM image based on the erroneous recognition image and the refined image with the target score X %.

In step S2003, the cutout unit 1803 cuts out the difference image for the changeable area corresponding to the target score X %.

In step S2004, the cutout unit 1803 cuts out the SSIM image for the changeable area corresponding to the target score X %.

In step S2005, the cutout unit 1803 multiplies the cut-out difference image and the cut-out SSIM image and generates the multiplied image.

In step S2006, the cutout unit 1803 performs the enhancement process on the multiplied image. In addition, the action unit 1804 subtracts the multiplied image that has undergone the enhancement process, from the erroneous recognition image, and outputs the action result image corresponding to the target score X %.

As is clear from the above description, the analysis device 100 according to the fourth embodiment generates the difference images and the SSIM images based on the erroneous recognition image and the refined images with each level of recognition accuracy and outputs the important portions by cutting out and multiplying the changeable areas corresponding to each level of recognition accuracy.

As described above, in the analysis device according to the fourth embodiment, by outputting the important portion in the changeable area in pixel units, the degree of influence of each image part that causes erroneous recognition may be visualized in pixel units.

### Fifth Embodiment

In the above fourth embodiment, a case has been described in which the degree of influence of each image part that causes erroneous recognition is visualized in pixel units, using the difference images and the SSIM images generated based on the erroneous recognition image and the refined images with each level of recognition accuracy.

In contrast to this, in a fifth embodiment, the degree of influence of each image part that causes erroneous recognition is visualized in pixel units, by further using important feature maps corresponding to each level of recognition accuracy. The fifth embodiment will be described below focusing on differences from the fourth embodiment described above.

<Functional Configuration of Detailed Cause Analysis Unit>

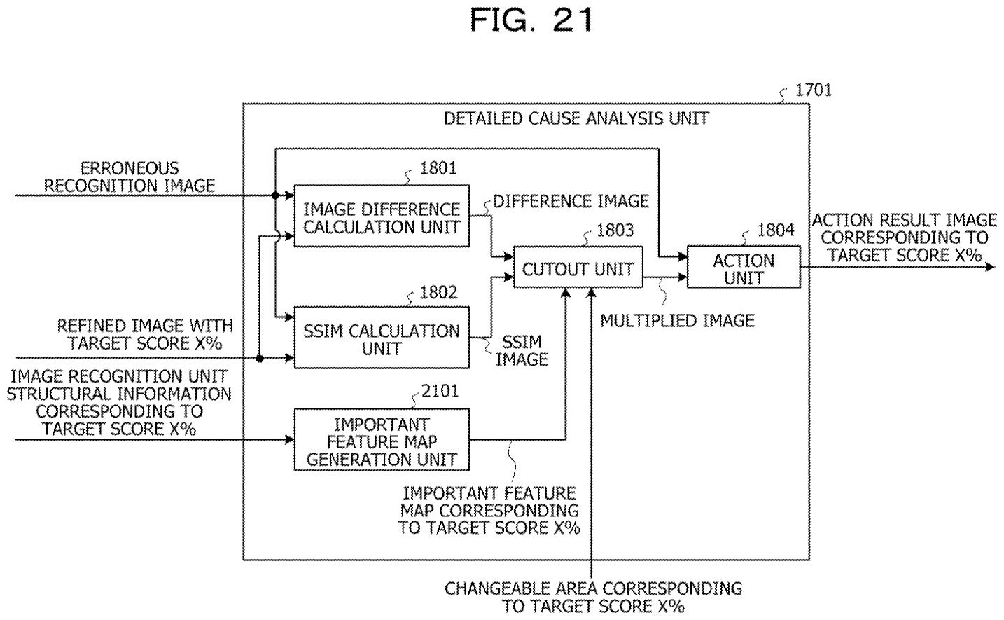

First, a functional configuration of a detailed cause analysis unit in an analysis device 100 according to the fifth embodiment will be described. FIG. 21 is a second diagram illustrating an example of the functional configuration of the detailed cause analysis unit. The difference from the functional configuration of the detailed cause analysis unit illustrated in FIG. 19 is that, in the case of FIG. 21, an important feature map generation unit 2101 is included.

The important feature map generation unit 2101 acquires image recognition unit structural information corresponding to each target score (here, for simplification of explanation, the image recognition unit structural information corresponding to the target score X %) from an image recognition unit 403. In addition, the important feature map generation unit 2101 generates an important feature map corresponding to the target score X %, based on the image recognition unit structural information corresponding to the target score X % by using the selective BP method.

In the present embodiment, using the difference image, the SSIM image, and the important feature map corresponding to the target score X % generated based on
the erroneous recognition image,
the refined image with the target score X %, and
the image recognition unit structural information corresponding to the target score X %,

the detailed cause analysis unit 1701 visualizes the important portion in the changeable area and outputs the visualized important portion as the action result image corresponding to the target score X %.

Note that, in the present embodiment, the difference image, the SSIM image, and the important feature map corresponding to the target score X % that are used by the detailed cause analysis unit 1701 to output the action result image corresponding to the target score X % have attributes as follows.
Difference image: difference information for each pixel, which is information having positive and negative values indicating how much the pixel is supposed to be corrected in order to raise the classification probability of the located label from the erroneous recognition state.
SSIM image: difference information that takes into account the shift statuses of the entire image and local areas, which is information having less artifacts (unintended noise) than the difference information for each pixel. For example, this is more accurate difference information (however, is information with only positive values).
Important feature map corresponding to the target score X %: a map that visualizes a feature portion of the correct answer label that affects the image recognition process.

<Specific Example of Processing of Detailed Cause Analysis Unit>

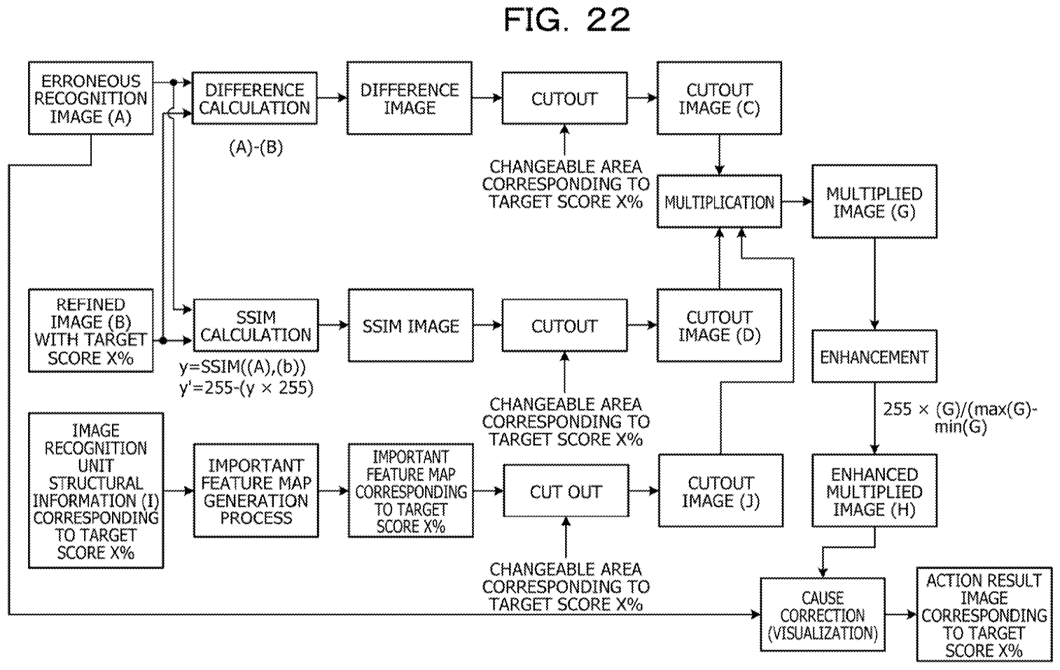

Next, a specific example of processing of the detailed cause analysis unit 1701 will be described. FIG. 22 is a second diagram illustrating a specific example of processing of the detailed cause analysis unit. Note that the differences from the specific example of processing of the detailed cause analysis unit 1701 in FIG. 19 is that the important feature map generation unit 2101 performs an important feature map generation process based on image recognition unit structural information (I) corresponding to the target score X % to generate the important feature map. In addition, a cutout unit 1803 cuts out the image portion for the changeable area corresponding to the target score X % from the important feature map corresponding to the target score X % and outputs a cutout image (J). Furthermore, the cutout unit 1803 multiplies a cutout image (C), a cutout image (D), and the cutout image (J) to generate a multiplied image (G).

<Flow of Detailed Cause Analysis Process>

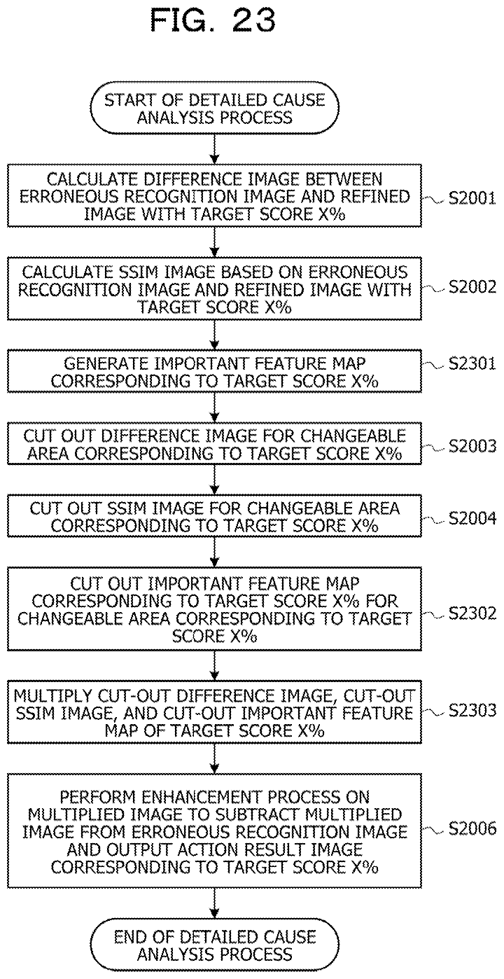

Next, the flow of a detailed cause analysis process by the detailed cause analysis unit 1701 will be described. FIG. 23 is a second flowchart illustrating a flow of the detailed cause analysis process. The differences from the flowchart illustrated in FIG. 20 are steps S2301, S2302, and S2303.

In step S2301, the important feature map generation unit 2101 acquires, from the image recognition unit 403, the image recognition unit structural information corresponding to the target score X % when the image recognition process was performed with the refined image with the target score X % as an input. In addition, the important feature map generation unit 2101 generates the important feature map corresponding to the target score X %, based on the image recognition unit structural information corresponding to the target score X % by using the selective BP method.

In step S2302, the cutout unit 1803 cuts out the image portion for the changeable area corresponding to the target score X % from the important feature map corresponding to the target score X %.

In step S2303, the cutout unit 1803 multiplies the difference image, the SSIM image, and the important feature map corresponding to the target score X %, which have been obtained by cutting out the image portions for the changeable area corresponding to the target score X %, and generate the multiplied image.

As is clear from the above description, the analysis device 100 according to the fifth embodiment generates the difference images, the SSIM images, and the important feature maps corresponding to each level of recognition accuracy, based on
the erroneous recognition image,
the refined images with each level of recognition accuracy, and
the image recognition unit structural information corresponding to each level of recognition accuracy, and

outputs the important portions by cutting out and multiplying the changeable areas corresponding to each level of recognition accuracy.

As described above, in the analysis device according to the fifth embodiment, by outputting the important portion in the changeable area in pixel units, the degree of influence of each image part that causes erroneous recognition may be visualized in pixel units.

### Sixth Embodiment

In a sixth embodiment, an embodiment in which the degree of influence of each image part that causes erroneous recognition is visualized in pixel units, using difference images generated based on the erroneous recognition image and the refined images with each level of recognition accuracy (an embodiment different from the above fourth embodiment) will be described. The sixth embodiment will be described below focusing on differences from the fourth embodiment described above.

<Functional Configuration of Detailed Cause Analysis Unit>

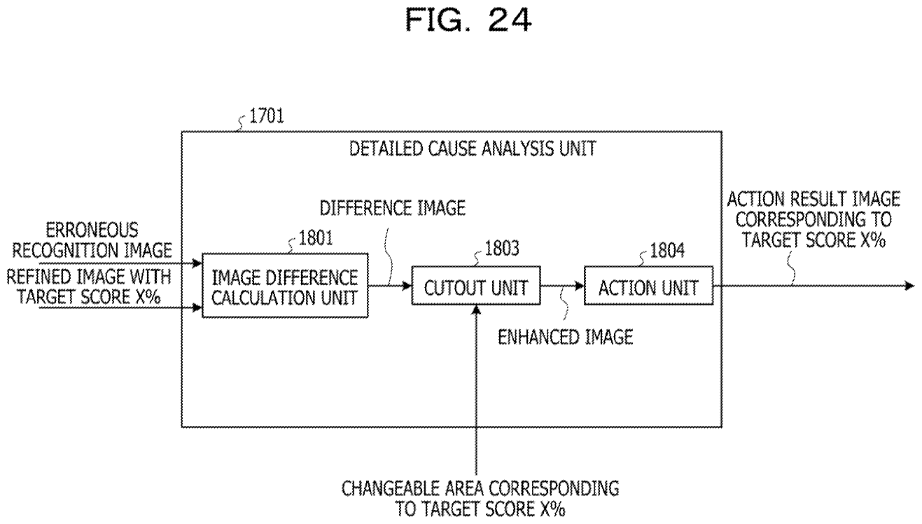

First, a functional configuration of a detailed cause analysis unit in an analysis device 100 according to the sixth embodiment will be described. FIG. 24 is a third diagram illustrating an example of the functional configuration of the detailed cause analysis unit. The difference from the functional configuration of the detailed cause analysis unit 1701 illustrated in FIG. 18 is that, in the case of FIG. 24, the SSIM calculation unit 1802 is not included.

In the present embodiment, a detailed cause analysis unit 1701 visualizes the important portion in the changeable area, using the difference image generated based on
the erroneous recognition image, and
the refined image with the target score X %,

and outputs the visualized important portion as the action result image corresponding to the target score X %.

Note that, in the present embodiment, the difference image used by the detailed cause analysis unit 1701 to output the action result image corresponding to the target score X % has attributes as follows.
Difference image: difference information for each pixel, which is information having positive and negative values indicating how much the pixel is supposed to be corrected in order to raise the classification probability of the located label from the erroneous recognition state.

<Specific Example of Processing of Detailed Cause Analysis Unit>

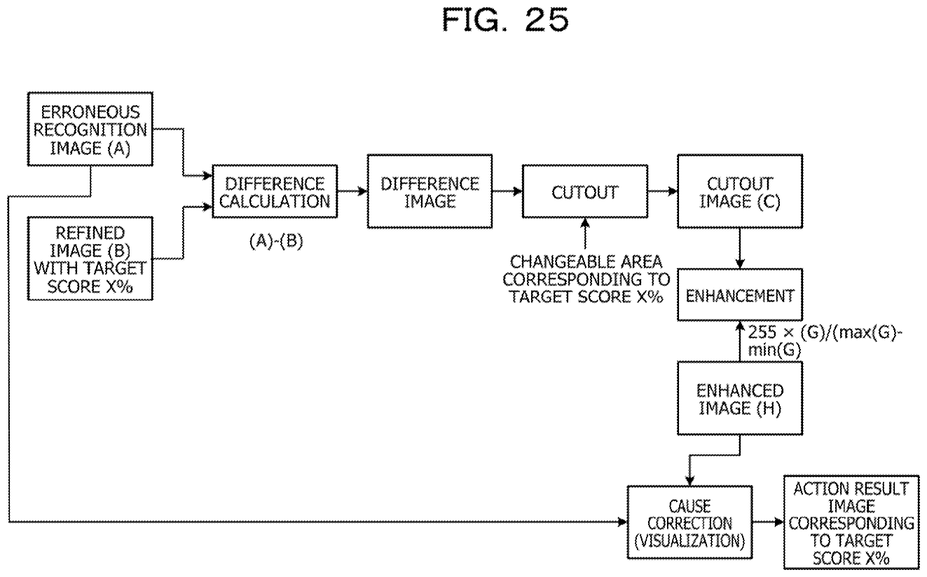

Next, a specific example of processing of the detailed cause analysis unit 1701 will be described. FIG. 25 is a third diagram illustrating a specific example of processing of the detailed cause analysis unit. Note that the differences from the specific example of processing of the detailed cause analysis unit 1701 in FIG. 19 are that there is no description regarding the cutout image (D) cut out by the SSIM calculation unit 1802 and there is no description regarding the multiplication process with the cutout image (C).

<Flow of Detailed Cause Analysis Process>

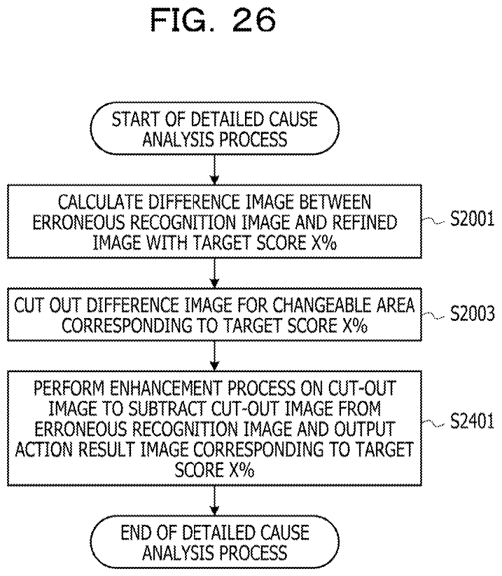

Next, the flow of a detailed cause analysis process by the detailed cause analysis unit 1701 will be described. FIG. 26 is a third flowchart illustrating a flow of the detailed cause analysis process. The differences from the flowchart illustrated in FIG. 20 are that the respective processes in steps S2002, S2004, and S2005 are not provided, and the process in step S2401 is executed instead of step S2006.

As illustrated in FIG. 26, in step S2001, an image difference calculation unit 1801 calculates the difference image between the erroneous recognition image and the refined image with the target score X %.

In step S2003, a cutout unit 1803 cuts out the changeable area corresponding to the target score X % from the difference image.

In step S2401, the cutout unit 1803 performs an enhancement process on the cut-out difference image. In addition, an action unit 1804 subtracts the difference image that has undergone the enhancement process, from the erroneous recognition image, and outputs the action result image corresponding to the target score X %.

As is clear from the above description, the analysis device 100 according to the sixth embodiment generates the difference images based on the erroneous recognition image and the refined images with each level of recognition accuracy and outputs the important portions by cutting out and enhancing the changeable areas corresponding to each level of recognition accuracy.

As described above, in the analysis device according to the sixth embodiment, by outputting the important portion in the changeable area in pixel units, the degree of influence of each image part that causes erroneous recognition may be visualized in pixel units.

### OTHER EMBODIMENTS

In each of the above embodiments, a case where the refined image generation unit 142, the map generation unit 143, and the specifying unit 1001 perform processing using the erroneous recognition image has been described. However, the refined image generation unit 142, the map generation unit 143, and the specifying unit 1001 may perform processing using the refined image generated by the image refiner initialization unit 141 executing the first learning process, instead of the erroneous recognition image.

In addition, in each of the above embodiments, the recognition accuracy has been described as a score, but recognition accuracy other than the score may be used. For example, the recognition accuracy other than the score mentioned here includes the position and dimensions, existence probability, intersection over union (IoU), segment, other information regarding the output of deep learning, and the like.

Furthermore, in each of the above embodiments, a case where one object is included in the erroneous recognition image has been described, but a plurality of objects may be included. In this case, the erroneous recognition cause information may be output for each object, or the erroneous recognition cause information including a plurality of objects may be output.

In addition, in each of the above embodiments, it has been described that the first learning process is executed such that the erroneous recognition image in the same state as the input erroneous recognition image is generated. However, the method for the first learning process is not limited to this.

The purpose of executing the first learning process on the image refiner unit 301 is to learn model parameters to a predefined initial state instead of an unknown initial state before performing the second learning process. Accordingly, in the first learning process, apart from the method of updating the model parameters such that the erroneous recognition image in the same state as the input erroneous recognition image is generated, a predetermined targeted score may be predefined to perform initialization such that an image that outputs the score is generated.

In this case, the score of the first learning process does not necessarily have to be a score lower than the score when the image recognition process is executed on the refined image generated by executing the second learning process. For example, the first learning process may be executed on the image refiner unit 301 such that an image that gives the score=100% is generated, and the refined images that give the scores=90%, 80%, and 70% may be generated in the second learning process. Alternatively, the first and second learning processes may be executed in accordance with other fluctuation patterns of the score.

In addition, the coefficient for performing the enhancement process in the above fourth to sixth embodiments may be selected so as to adjust the action result image or the strength of the action on the refined image. For example, when it is difficult to distinguish the magnitude of the pixel value indicating the cause of erroneous recognition, the coefficient may be selected so as to promote the enhancement. Alternatively, the coefficient may be selected such that the scale of the pixel value changed by the action of multiplication is optimally adjusted, or the coefficient may be selected so as not to perform the enhancement process.

In addition, in the first learning process of learning such that the recognition accuracy of the image generated by the generative model matches the desired recognition accuracy, the output of the hidden layer of deep learning may be used together with the information regarding the output of deep learning mentioned above or the like (or may be used alone).

For example, when a feature map is also used together as the output of the hidden layer, the first learning process may be executed such that the information regarding the output of deep learning (image recognition unit) to be analyzed and the information regarding the output of the hidden layer of deep learning (image recognition unit) to be analyzed

have the same state
when the input erroneous recognition image is processed, and
when the image generated by the first learning process is processed.

When the information regarding the output of the hidden layer of deep learning (image recognition unit) to be analyzed is evaluated, for example,

evaluation may be made by executing some processing for evaluating whether the same state is achieved, such as
L1/L2/SSIM,
Neural Style Transfer loss, or
Max Pooling or Average Pooling.

Note that the embodiments are not limited to the configurations described here and may include, for example, combinations of the configurations or the like described in the above embodiments with other elements. These points may be changed without departing from the spirit of the embodiments and may be appropriately assigned according to application modes thereof.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An analysis device comprising:
a memory; and
a processor coupled to the memory and configured to:
execute a first learning process on a generative model for images such that the images that bring a recognition result of an image recognition process into a preassigned state are generated;
execute a second learning process on the generative model on which the first learning process has been executed, while gradually changing recognition accuracy of the images generated by the generative model on which the first learning process has been executed, to desired recognition accuracy;
acquire each piece of information on back-error propagation calculated by executing the image recognition process, for the images with each level of the recognition accuracy generated through a course of the second learning process; and
generate evaluation information that indicates each of image parts that cause erroneous recognition at each level of the recognition accuracy, based on the acquired each piece of the information on the back-error propagation.

2. The analysis device according to claim 1, wherein the processor:
executes the first learning process on the generative model for the images such that the images in a same state as input images are generated, and
executes the second learning process on the generative model on which the first learning process has been executed, while gradually raising the recognition accuracy of the images generated by the generative model on which the first learning process has been executed, to the desired recognition accuracy.

3. The analysis device according to claim 2, wherein the processor:
separately generates important feature maps that visualize feature portions that reacted during the image recognition process, based on the acquired each piece of the information on the back-error propagation;
generates a plurality of difference maps by calculating differences between the separately generated important feature maps; and
among the separately generated important feature maps, generates a predetermined important feature map and each of added important feature maps obtained by sequentially adding the plurality of difference maps to the predetermined important feature map, as the evaluation information.

4. The analysis device according to claim 3, wherein the processor
generates an important feature index map in which a deterioration scale map obtained by calculating the differences between the input images or the images generated by executing the first learning process, and the images that are generated by executing the second learning process and have the desired recognition accuracy is superimposed on the predetermined important feature map, and each of added important feature index maps obtained by sequentially adding the plurality of difference maps to the important feature index map, as the evaluation information.

5. The analysis device according to claim 4,
wherein the processor:
divides the input images or the images generated by executing the first learning process for each of superpixels; and
adds a value of each pixel of the important feature index map for each of the superpixels, and generates areas indicated by combinations of the superpixels whose additional values are equal to or higher than a predetermined threshold value, as the evaluation information.

6. The analysis device according to claim 5, wherein the processor
composites the input images or the images generated by executing the first learning process, and the images generated by executing the second learning process, based on the combinations of the superpixels whose additional values are equal to or higher than the predetermined threshold value, and specifies the combinations of the superpixels, based on a result of the image recognition process executed on composite images.

7. The analysis device according to claim 6, wherein the processor
calculates the differences in pixel units between the input images or the images generated by executing the first learning process, and the images generated by executing the second learning process, which are the images included in the areas indicated by the specified combinations of the superpixels, and generates the images obtained from the calculated differences in pixel units, as the evaluation information.

8. A non-transitory computer-readable recording medium storing an analysis program causing a computer a processing of:
executing a first learning process on a generative model for images such that the images that bring a recognition result of an image recognition process into a preassigned state are generated;
executing a second learning process on the generative model on which the first learning process has been executed, while gradually changing recognition accuracy of the images generated by the generative model on which the first learning process has been executed, to desired recognition accuracy; and
acquiring each piece of information on back-error propagation calculated by executing the image recognition process, for the images with each level of the recognition accuracy generated through a course of the second learning process; and
generating evaluation information that indicates each of image parts that cause erroneous recognition at each level of the recognition accuracy, based on the acquired each piece of the information on the back-error propagation.
